(19) United States
(12) Patent Application Publication
(10) Pub. No.: US 2012/0051860 A1
(43) Pub. Date: Mar. 1, 2012

(54) Seismic tool assembly for use in anchor insertion

(76) Inventor: Robert Cousineau, Ottawa (CA)

(21) Appl. No.: 13/067,144

(22) Filed: May 12, 2011

Related U.S. Application Data
(63) Continuation-in-part of application No. 12/805,973, filed on Aug. 27, 2010.

(30) Foreign Application Priority Data
Aug. 27, 2010 (CA) 2,713,244
Sep. 15, 2010 (CA) PCT/CA2010/001456
Dec. 10, 2010 (CA) 2,725,069

(51) Int. Cl. B23B 51/08

(52) U.S. Cl. 408/83

(57) ABSTRACT

A seismic tool assembly for effecting a drill hole and enlarging a lowermost end thereof whereby an anchor can be set more securely therein. A drill bit is inserted through an opening in a drill stop member, which is mounted on a stabilizer mounted within at least a portion of the drill hole. The bit is then inserted through each of the drill stop member and the stabilizer to attain a drilling position. The lower end of the bit has a cutting portion having a cutting radius greater than that of the bit body whereby, when the bit is inserted fully into a lowermost end of the hole and rotated, the cutting portion enlarges the lowermost end, whereby flanged portions of an anchor will rest within the enlarged area, retaining the anchor in place.

The present invention relates to a seismic tool assembly meant to be used for the later insertion and setting of anchors, such as drop-in and wedge type anchors into brittle materials such as concrete, stone, masonry and cementuous materials. More particularly, the present invention relates to a seismic tool assembly for effecting a drill hole and enlarging a lowermost end thereof to have a greater circumference than that of the remainder of the drill hole whereby an anchor can be set more securely therein.

### BACKGROUND OF THE INVENTION

Anchors are conventionally used in construction to attach various components of a building construction to an overhead ceiling or other structure. Such components to be attached can relate to, for example, services that provide plumbing, electrical, drainage, sprinkler system piping and drop ceilings. From these anchors, which are usually of the wedge or drop-in type variety, all of the above services and ceilings are suspended or secured.

Conventionally, in setting anchors in concrete to suspend an awning, for example, a hole is pre-drilled in the surface to which the anchor is to be applied, and then the anchor is inserted into the pre-drilled hole. However, when setting such anchors in concrete it is not uncommon for such anchors to weaken and loosen over time, particularly in situations where cracking or chipping of the concrete around the pre-drilled hole has occurred.

Furthermore, studies have revealed that cracking can typically occur in the concrete element, and that such cracks can significantly impact the performance of anchors. Cracks can originate on a concrete beam or slab in a variety of ways, such as creep, temperature settlement of the support or foundation, thermal expansion and contraction stress overload, or from a natural disaster such as an earthquake or flood. In such situations, the situation can arise where, if one such concrete anchor fails and lets go, the remaining anchors, by virtue of the weight they additionally assume in light of such failure, can also similarly collapse and fail.

It has been found that enlarging the lowermost (interior) portion of a drill hole can allow an anchor to be set more securely therein. It has further been found that providing a drill hole with an enlarged lower end having a greater circumference than that of the remainder of the drill hole can be advantageously provided by a drill bit having an enlarged cutting portion adjacent the tip, which is inserted into the drill hole, whereby the enlargement of the cutting portion is configured so that it can pass through the shaft of the pre-drilled hole to be enlarged.

It would therefore be advantageous to have an improved seismic tool assembly meant to be used for the later insertion and setting of anchors into brittle materials such as concrete, stone, masonry and cementuous materials.

It would be further advantageous to have an improved seismic tool assembly for use in a one step process for both creating a drill hole and, at the same time, enlarging a lowermost end of a drill hole, wherein the lowermost end of the drill hole can be further drilled and enlarged to have a greater circumference than that of the remainder of the drill hole, wherein an anchor can later be positioned and securely retained within the enlarged area.

It would also be further advantageous to have an improved seismic tool assembly meant to be used for the later insertion and setting of anchors which utilizes a stabilizer having an opening corresponding with the drill hole for receiving an insertion of the bit body into the drill hole, so as to aid in accurately inserting the drill bit into the drill hole. It would also be still further advantageous to have a stabilizer which possesses a lower end having a larger sized opening greater than that of the bit body, so as to increase the range of motion of the drilling bit and permit limited tilting movement of the bit within the stabilizer during the drilling process so as to further aid in enlarging a lowermost end of the drill hole to receive an anchor. To this end, the present invention effectively addresses this need.

### SUMMARY OF THE INVENTION

The present invention provides an improved seismic tool assembly meant to be used for the later insertion and setting of anchors for the insertion and setting of anchors into brittle materials such as concrete, stone, masonry and cementuous materials.

The present invention also provides an improved seismic tool assembly meant to be used for the later insertion and setting of anchors, which can be used in a one step process for both creating a drill hole and, at the same time, for enlarging a lowermost end of a drill hole to have a greater circumference than that of the remainder of the drill hole, whereby an anchor can be later set and positioned more securely therein.

The present invention also provides an improved seismic tool assembly meant to be used for the later insertion and setting of anchors which utilizes a stabilizer having an opening corresponding with the drill hole for receiving an insertion of the bit body into the drill hole, so as to aid in accurately inserting the drill bit into the drill hole.

The present invention also provides an improved seismic tool assembly meant to be used for the later insertion and setting of anchors which utilizes a stabilizer which possesses a lower end having a larger sized opening greater than that of the bit body, so as to increase the range of motion of the drilling bit and permit limited tilting movement of the bit within the stabilizer during the drilling process so as to further aid in enlarging a lowermost end of the drill hole to receive an anchor. The present invention also provides an improved seismic tool assembly wherein a drill stop member permits a tilted controlled rotation within the stabilizer.

According to a first broad aspect of an embodiment of the present invention, there is disclosed a seismic tool assembly for effecting a drill hole and enlarging a lowermost end thereof for a later insertion and setting of anchors therein, the assembly comprising a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body; a drill stop member having an opening defined therethrough corresponding with the drill hole and for receiving an insertion of the bit body therethrough; a restrictive disk for substantially covering an upper surface of the drill stop member and having an opening defined therethrough corresponding with the drill hole and for receiving an insertion of the bit body therethrough; a stabilizer for mounting within at least a portion of the drill hole and having a recessed interior portion which is constructed and arranged for having the drill stop member mounted thereon, the stabilizer further comprising (a) a flange portion constructed and arranged to extend into the drill hole and abut an inside portion thereof; (b) a central opening corresponding with the opening of the drill stop member, the central opening providing a space between the bit body and the flange portion to permit limited tilting movement of the bit body during a drilling process to enlarge the lowermost end of the drill hole; (c) a threaded portion on an upper interior surface of the stabilizer; (d) a securing portion having an opening defined therethrough for receiving an insertion of the bit body therethrough, and corresponding with the central opening of the stabilizer, a lower end of the securing portion being threaded so as to permit threaded engagement of the securing portion to the threaded portion of the stabilizer so as to prevent disengagement of the drill stop member from the stabilizer during the drilling process.

According to another aspect of the present invention, there is disclosed a seismic tool assembly for effecting a drill hole and enlarging a lowermost end thereof for a later insertion and setting of anchors therein, the assembly comprising a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body; a drill stop member having an opening defined therethrough corresponding with the drill hole and for receiving an insertion of the bit body therethrough and comprising: (a) threads on an uppermost exterior surface thereof; (b) an upper portion having threads on an interior surface thereof, which can be matingly engaged with the threads on the uppermost exterior surface of the drill stop member to secure the upper portion to the drill stop member, the upper portion having opening defined therethrough corresponding with the opening in the drill stop member for receiving an insertion of the bit body therethrough; a restrictive disk for substantially covering an upper surface of the drill stop member and having an opening defined therethrough corresponding with the drill hole and for receiving an insertion of the bit body therethrough, the opening of the restrictive disk having a shape which corresponds substantially to a shape of the cutting portion and the bit body; a stabilizer for mounting within at least a portion of the drill hole and having a recessed interior portion which is constructed and arranged for having the drill stop member mounted thereon, the stabilizer further comprising: (a) a flange portion constructed and arranged to extend into the drill hole and abut an inside portion thereof; (b) a central opening corresponding with the opening of the drill stop member, the central opening providing a space between the bit body and the flange portion to permit limited tilting movement of the bit body during a drilling process to enlarge the lowermost end of the drill hole; (c) a threaded portion on an upper interior surface of the stabilizer; (d) a securing portion having an opening defined therethrough for receiving an insertion of the bit body therethrough, and corresponding with the central opening of the stabilizer, a lower end of the securing portion being threaded so as to permit threaded engagement of the securing portion to the threaded portion of the stabilizer so as to prevent disengagement of the drill stop member from the stabilizer during the drilling process; and a cap portion having threads on an interior surface thereof, wherein the threads of the cap portion can be matingly engaged with the threaded portion of the upper portion of the drill stop member, the cap portion having an opening corresponding with the opening in the drill stop member for receiving an insertion of the bit body therethrough.

According to a further broad aspect of an embodiment of the present invention, there is disclosed a seismic tool assembly for effecting a drill hole and enlarging a lowermost end thereof for a later insertion and setting of anchors therein, the assembly comprising a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body, and wherein the bit body further comprises an abutment member formed thereon having a greater width than a remainder of the bit body; a drill stop member having an opening defined therethrough corresponding with the drill hole and for receiving an insertion of the bit body therethrough; a stabilizer for mounting within at least a portion of the drill hole and having a recessed interior portion which is constructed and arranged for having the drill stop member mounted thereon, the stabilizer further comprising a flange portion constructed and arranged to extend into the drill hole and abut an inside portion thereof; a central opening corresponding with the opening of the drill stop member, the central opening providing a space between the bit body and the flange portion to permit limited tilting movement of the bit body during a drilling process to enlarge the lowermost end of the drill hole; a threaded portion on an upper interior surface of the stabilizer; a securing portion having an opening defined therethrough for receiving an insertion of the bit body therethrough, and corresponding with the central opening of the stabilizer, a lower end of the securing portion being threaded so as to permit threaded engagement of the securing portion to the threaded portion of the stabilizer so as to prevent disengagement of the drill stop member from the stabilizer during the drilling process; and a cap portion having threads on an interior surface thereof, wherein the threads of the cap portion can be matingly engaged with the threaded portion of the upper portion of the drill stop member, the cap portion having an opening corresponding with the opening in the drill stop member for receiving an insertion of the bit body therethrough, and wherein the abutment member is constructed and arranged to contact an uppermost end of the drill stop member when the bit body is inserted therethrough, restricting downward movement of the bit body to a pre-set depth.

According to a further broad aspect of an embodiment of the present invention, there is disclosed a seismic anchor insertion assembly for insertion into a drill hole to effect placement of an anchor, the assembly comprising a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body; a drill stop member having an opening defined therethrough corresponding with the drill hole and for receiving an insertion of the bit body into the drill hole, an upper end of the drill stop member having a narrower opening for receiving the insertion of the bit body therein and the lower end of the drill stop member having an opening greater than that of the upper end, so as to permit limited tilting movement of the bit body within the drill stop member during a drilling process to further enlarge a lowermost end of the drill hole; a stabilizer having a flange portion constructed and arranged to extend into the drill hole and abut an inside portion thereof, the stabilizer being constructed and arranged for having the drill stop member mounted thereon and having a central opening corresponding with each of the openings of the drill stop member and the drill hole; and locking means on the stabilizer for selectively stabilizing the bit body and for preventing disengagement of the bit body from the drill stop member and the stabilizer.

According to another broad aspect of the present invention, there is disclosed a seismic tool assembly for effecting a drill hole and enlarging a lowermost end thereof for a later insertion and setting of anchors therein, the assembly comprising a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body; a drill stop member having an opening defined therethrough corresponding with the drill hole and for receiving an insertion of the bit body therethrough, the drill stop member further comprising: a lower portion; a recessed middle portion; and an upper portion, each of the portions being connected together, and the lower portion and the upper portion having an outermost width that is greater than that of the recessed middle portion; a stabilizer for mounting within at least a portion of the drill hole and having a recessed interior portion which is constructed and arranged for having the drill stop member mounted thereon, the stabilizer having a central opening corresponding with each of the openings of the drill stop member and further comprising: a flange portion constructed and arranged to extend into the drill hole and abut an inside portion thereof; holding screws connected at opposed sides of an upper portion of the stabilizer, the holding screws being adjustably movable towards the recessed middle portion of the drill stop member so as to prevent disengagement of the drill stop member from the stabilizer during a drilling process, or adjustably movable away from the recessed middle portion of the drill stop member so as to permit disengagement of the drill stop member from the stabilizer.

According to another aspect of the present invention, there is provided a seismic tool assembly for effecting a drill hole and enlarging a lowermost end thereof for a later insertion and setting of anchors therein, the assembly comprising a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body; a drill stop member having an opening defined therethrough corresponding with the drill hole and for receiving an insertion of the bit body therethrough, the drill stop member further comprising a lower portion; a recessed middle portion; and an upper portion, each of the portions being connected together, and the lower portion and the upper portion having an outermost width that is greater than that of the recessed middle portion; a stabilizer for mounting within at least a portion of the drill hole and having a recessed interior portion which is constructed and arranged for having the drill stop member mounted thereon, the stabilizer having a central opening corresponding with each of the openings of the drill stop member and further comprising a flange portion constructed and arranged to extend into the drill hole and abut an inside portion thereof; holding screws connected at opposed sides of an upper portion of the stabilizer, the holding screws being adjustably movable towards the recessed middle portion of the drill stop member so as to prevent disengagement of the drill stop member from the stabilizer during a drilling process, or adjustably movable away from the recessed middle portion of the drill stop member so as to permit disengagement of the'drill stop member from the stabilizer.

According to another aspect of the present invention, there is provided a seismic tool assembly for effecting a drill hole and enlarging a lowermost end thereof for a later insertion and setting of anchors therein, the assembly comprising a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body; a drill stop member having an opening defined therethrough corresponding with the drill hole and for receiving an insertion of the bit body therethrough; a stabilizer for mounting above the drill hole and having a recessed interior portion which is constructed and arranged for abutment with the drill stop member positioned therein so as to restrict the bit body to achieving a pre-set cutting depth within the drill hole, the stabilizer having a central opening corresponding with the opening of the drill stop member and further comprising a bottom portion constructed and arranged to substantially surround the drill hole; and a threaded upper portion; a cap portion having an opening defined therethrough for receiving an insertion of the bit body therethrough, and corresponding with the central opening of the stabilizer, an upper end of the cap portion being threaded so as to permit threaded engagement of the cap portion to the threaded upper portion of the stabilizer so as to prevent disengagement of the drill stop member from the stabilizer during a drilling process.

According to another aspect of the present invention, there is provided a seismic tool assembly for effecting a drill hole and enlarging a lowermost end thereof for a later insertion and setting of anchors therein, the assembly comprising a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body; a drill stop member having an opening defined therethrough corresponding with the drill hole and for receiving an insertion of the bit body therethrough; a stabilizer for mounting above the drill hole and having a recessed interior portion which is constructed and arranged for abutment with the drill stop member positioned therein so as to restrict the bit body to achieving a pre-set cutting depth within the drill hole, the stabilizer having a central opening corresponding with the opening of the drill stop member and further comprising a bottom portion constructed and arranged to substantially surround the drill hole; an upper portion; and locking means positioned substantially around the upper portion of the stabilizer for selectively stabilizing the bit body and for preventing disassembly of the bit body from the drill stop member and the stabilizer.

According to another aspect of the present invention, there is provided a seismic tool assembly for effecting a drill hole for a later insertion and setting of anchors therein, the assembly comprising a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body; a drill stop member having an opening defined therethrough corresponding with the drill hole and for receiving an insertion of the bit body therethrough; a stabilizer for mounting within at least a portion of the drill hole and having a recessed interior portion which is constructed and arranged for having the drill stop member mounted thereon, the stabilizer having a central opening corresponding with each of the openings of the drill stop member and further comprising a bottom portion constructed and arranged to substantially surround the drill hole, the bottom portion having an internally threaded opening at a lowermost surface thereof; and a flange portion constructed and arranged to extend into the drill hole and abut an inside portion thereof, an upper end of the flange portion being threaded so as to permit threaded engagement of the flange portion to the threaded internally threaded opening of the bottom portion.

An important advantage of the present invention is that it provides an improved seismic tool assembly having a drill bit which can be connected to a conventional drill, for effecting a drill hole and enlarging a lowermost end thereof wherein an anchor can later be positioned and securely retained within the enlarged area. Further, the present invention provides a stabilizer for mounting within at least a portion of the drill hole, having an opening corresponding with the drill hole, for receiving an insertion of the drill bit into the drill hole, so as to aid in accurately inserting and positioning the drill bit into the drill hole.

Another important advantage of the present invention is that it provides an improved seismic tool assembly which utilizes a stabilizer having a threaded portion on an upper interior surface of the stabilizer and a securing portion threaded on a lower end thereof to permit threaded engagement of the securing portion to the threaded portion of the stabilizer so as to prevent disengagement of the drill stop member from the stabilizer during the drilling process.

Another important advantage of the present invention is that it provides an improved seismic tool assembly which utilizes a drill stop member having a lower portion, a recessed middle portion, and an upper portion, the lower portion and the upper portion having an outermost width that is greater than that of the recessed middle portion. The drill stop member is mounted on the stabilizer and has holding screws connected at opposed sides of an upper portion of the stabilizer, the holding screws being adjustably movable towards the recessed middle portion of the drill stop member so as to prevent disengagement of the drill stop member from the stabilizer during a drilling process, or adjustably movable away from the recessed middle portion of the drill stop member so as to permit disengagement of the drill stop member from the stabilizer.

### BRIEF DESCRIPTION OF THE DRAWINGS

The embodiments of the present invention will now be described by reference to the following figures, in which identical reference numerals in different figures indicate identical elements and in which:

FIG. 1 is a perspective view of an embodiment of the seismic drilling bit of the present invention;

FIG. 2 is a perspective view of an upper end of the drill stop member;

FIG. 3 is a perspective view of a lower end of the drill stop member;

FIG. 4 is an end view of the flange portion of the stabilizer, illustrating the locking means surrounding the flange portion and in an open unlocked position;

FIG. 5 is an end view of the flange portion of the stabilizer, illustrating the locking means surrounding the flange portion and in a closed locked position;

FIG. 6 is a top view of the stabilizer, illustrating the flange portion and the locking means surrounding the flange portion and illustrating side portions of the flange portion having an elongated opening defined along a length thereof, for allowing passage of the cutting portion of the bit body when the bit body is inserted through the stabilizer;

FIG. 7 is an end view of the stabilizer;

FIG. 8 is a side view illustrating the drill stop member mounted within the stabilizer;

FIG. 9 is a perspective view of the fully connected seismic tool assembly;

FIG. 10 is a side view illustrating the drill stop member mounted within the stabilizer;

FIG. 11 is a side view illustrating the drill stop member mounted within the stabilizer, and illustrating the seismic tool assembly effecting initially, a drill hole, and then enlarging a lower end of the drill hole;

FIG. 12A is a side view illustrating a further embodiment of a fully connected seismic tool assembly, and illustrating the drill stop member mounted within the stabilizer;

FIG. 12B is a side view illustrating a further embodiment of a fully connected seismic tool assembly, and illustrating the drill stop member mounted within the stabilizer and the flange portion extending at least partially into the drill hole;

FIG. 13A is a side view illustrating a further embodiment of a fully connected seismic tool assembly, and illustrating the drill stop member mounted within the stabilizer;

FIG. 13B is a side view illustrating the embodiment of a fully connected seismic tool assembly shown in FIG. 13A, and illustrating the flange portion of the stabilizer as being threadably disconnectable from the stabilizer;

FIG. 14 is a side view illustrating the embodiment of a fully connected seismic tool assembly shown in FIG. 13A, and illustrating the drill stop member mounted within the stabilizer;

FIG. 15 is a side view illustrating a still further embodiment of a fully connected seismic tool assembly;

FIG. 16 is a side view illustrating a still further embodiment of a fully connected seismic tool assembly;

FIG. 17 is an expanded view of the embodiment of the fully connected seismic tool assembly shown in FIG. 16;

FIG. 18 is an expanded view of the embodiment of the fully connected seismic tool assembly shown in FIG. 16;

FIG. 19 is an expanded view of the embodiment of the drill stop member and securing portion of the seismic tool assembly shown in FIG. 16;

FIG. 20 is an expanded view of the embodiment of the drill stop member, securing portion and the lower portion of the seismic tool assembly shown in FIG. 16;

FIG. 21 is an exploded view of the embodiment shown in FIG. 16, illustrating the upper portion and the cap portion of the seismic tool assembly; and

FIG. 22 is a further exploded view of the embodiment shown in FIG. 21, illustrating the upper portion and the cap portion.

FIG. 23 is a side view illustrating a still further embodiment of the seismic tool assembly;

FIG. 24 is an expanded view of the embodiment of the drill seismic drilling bit and cap portion of the seismic tool assembly shown in FIG. 23;

FIG. 25 is an expanded view of the embodiment of the drill stop member, securing portion and the lower portion of the seismic tool assembly shown in FIG. 23;

FIG. 26 is a perspective view of the embodiment of the drill stop member, securing portion and the lower portion shown in FIG. 25, in a fully connected state; and

FIG. 27 is a perspective view of the embodiment of the drill stop member, securing portion and the lower portion shown in FIG. 26, in a fully connected state, and with the seismic drilling bit inserted therethrough.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

The present invention consists of an improved seismic tool assembly designed for effecting a drill hole and enlarging a lowermost end thereof to have a greater circumference than that of the remainder of the drill hole whereby an anchor can be set more securely therein.

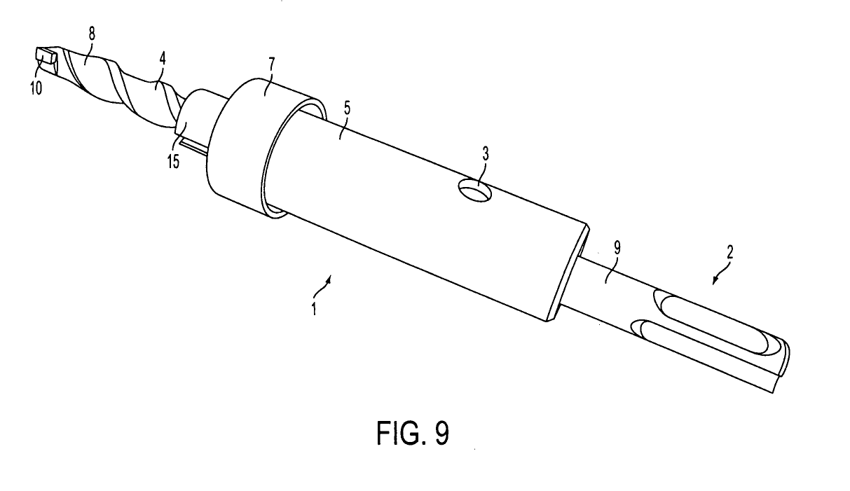

Referring to FIG. 9, there is shown a seismic tool assembly for use in the later insertion and setting of anchors shown generally at 1 in accordance with a first exemplary embodiment of the present invention. In a preferred embodiment, as hereinafter described, the seismic tool assembly 1 is to be rotatably mounted onto a drill by way of a drill spindle (not shown). It will be understood that there are numerous variations as to the types of attachments to a drill or otherwise that the seismic tool assembly 1 of the present invention could be mounted thereon, as would be readily apparent to one skilled in the art.

In a preferred embodiment, the seismic tool assembly 1 is for use in the later insertion and setting of anchors into concrete, stone, masonry and cementuous materials (though it will be understood that other variations to this are possible) and comprises a seismic drilling bit 2, a stabilizer 7, and a drill stop member 5, as hereinafter described.

Preferably, the seismic drilling bit 2 will be made of a durable, machinable metal and is substantially cylindrical in shape. The seismic drilling bit 2 is, preferably, of a one-piece construction that comprises an upper end 9 and a lower end 8 which are integrally connected to one another.

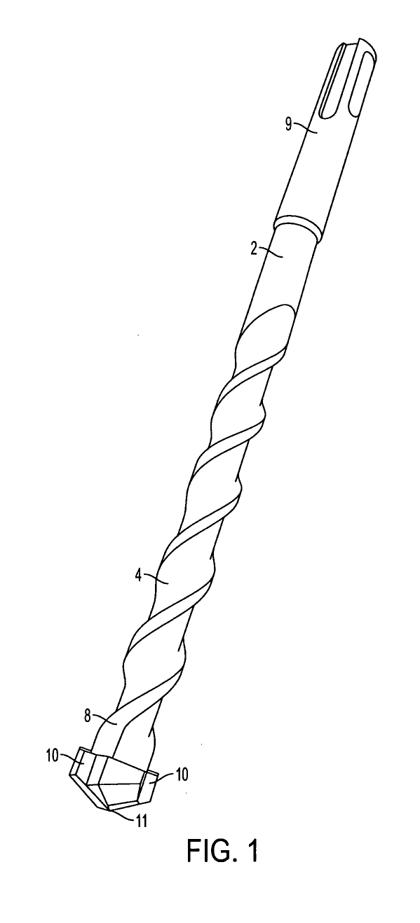

With reference to FIG. 1, it can be seen that the bit body 4 of the seismic drilling bit 2 can effect the drilling of a drill hole, and has a first diameter (and cutting radius) sized to readily fit into a drill hole (not shown), and possesses, as most conventional drill bits do, at least one cutting edge and at least one groove extending in a helical fashion along a length of the bit body 4 of the seismic drilling bit 2. In a preferred embodiment, these extend along a substantial length of the bit body 4, or, alternatively, extend along at least half a length of the bit body 4. Preferably, the first diameter of the upper end 9 of the bit body 4 is less than or equal to a diameter of the drill hole into which the seismic drilling bit 2 of the present invention is to be inserted.

The proximal upper end 9 of the seismic drilling bit 2 is constructed and arranged to be releasably secured to a drill by way of a drill spindle (not shown). In an alternative embodiment, the distal lower end 8 of the seismic drilling bit 2 can have a tapered end (not shown) and a drill tip 11 extending generally outwardly from the tapered end.

The lower end 8 of the seismic drilling bit 2 has a cutting portion 10 positioned on each side of the lower end 8 of the seismic drilling bit 2, the cutting portions 10 having a greater outermost width than that of the bit body 4 whereby, when the seismic drilling bit 2 is inserted fully into an lowermost end of the drill hole and rotated, so as to effect a conical shape in the drill hole, the cutting portions 10 enlarge a circumference of the drill hole at the lowermost end thereof that is greater than the circumference of the remainder of the shaft of the drill hole. Preferably, the cutting portions 10 extend outwardly from substantially around an entirety of the lower end 8 of the seismic drilling bit 2, as seen in FIG. 1. In an alternative embodiment (which is not shown), the lower end 8 of the seismic drilling bit 2 can have a cutting portion positioned on only one side of the lower end 8 of the seismic drilling bit 2.

In a still further embodiment (not shown), the bit body 4 of the seismic drilling bit 2 has a diameter (and cutting radius) that is less than that of the drill hole, with the cutting portions 10, of course, still having a greater outermost width (and cutting radius) than that of the bit body 4. In this manner, with the bit body 4 of the seismic drilling bit 2 having a width that is less than that of the drill hole, the initial insertion of the seismic drilling bit 2 into the drill hole is made easier, whereby the bit does not need to be as readily forcibly inserted.

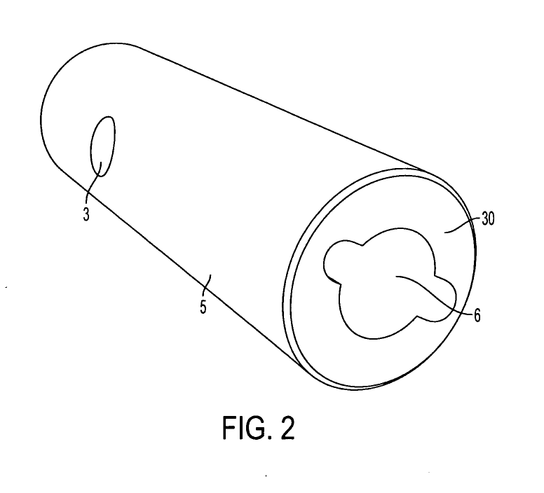

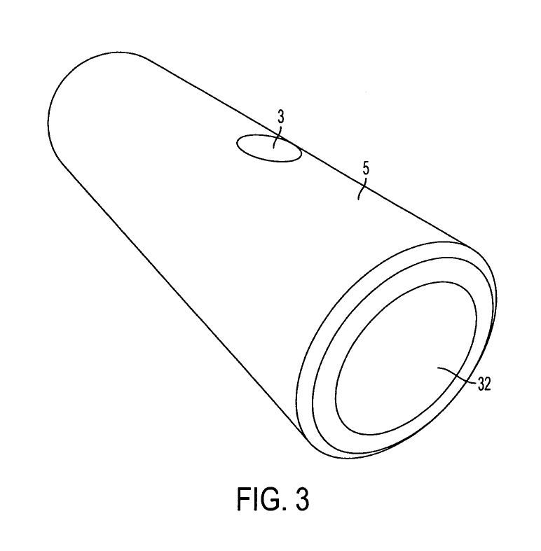

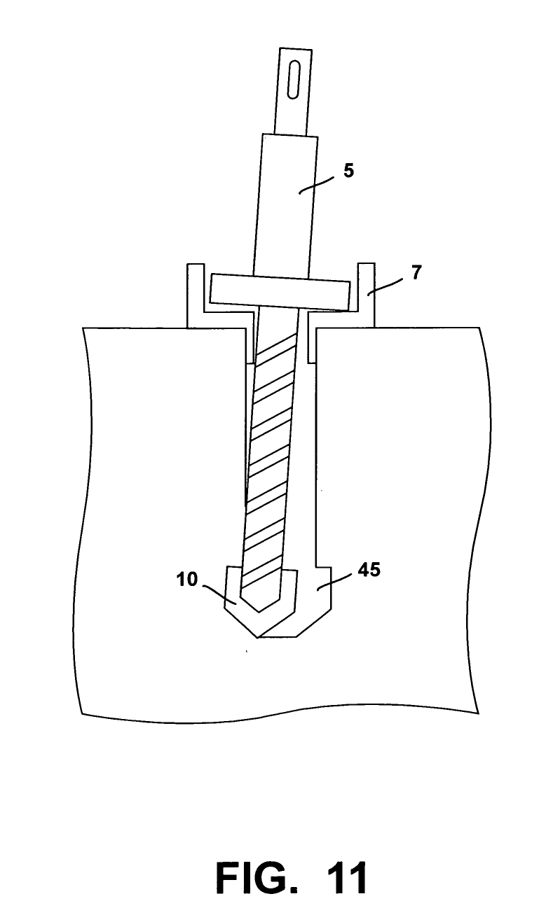

With reference to FIG. 2, the drill stop member 5, preferably, has an opening 6 defined therethrough, and is used for receiving an insertion of the seismic drilling bit 2. FIG. 2 illustrates the upper end 30 of the drill stop member 5 having a shape which corresponds substantially to a shape of the cutting portion 10 of the bit body 2 for receiving the insertion of the bit body therethrough. With reference to FIG. 3, it can be seen that the lower end 32 of the drill stop member 5 has an opening greater than that of the upper end 30, so as to permit limited tilting movement of the bit body from its vertical axis within the drill stop member 5 during the drilling process to further enlarge a lowermost end of the drill hole, it being understood that this tilting rotational drilling of the lower end of the drill hole by the drill bit 2 within the drill stop member 5 can be done through 360 degrees. This rotational movement can be seen with reference to FIG. 11, whereby the lower end of the drill hole 45 can be seen to be funnel-shaped, for receiving anchors therein.

Preferably, the opening in the drill stop member 5 is positioned at a substantially central location of the drill stop member 5. The drill stop member 5 aids in the accurate and gradual insertion of the seismic drilling bit 2 into the drill hole. The drill stop member 5 further comprises a dust exit opening 3 defined therein for allowing dust to be removed from the assembly during the drilling process, the dust exit opening 3 being positioned at substantially a middle portion of the drill stop member 5. It will, of course, also be understood that the stabilizer 7 could also possess such a dust exit opening.

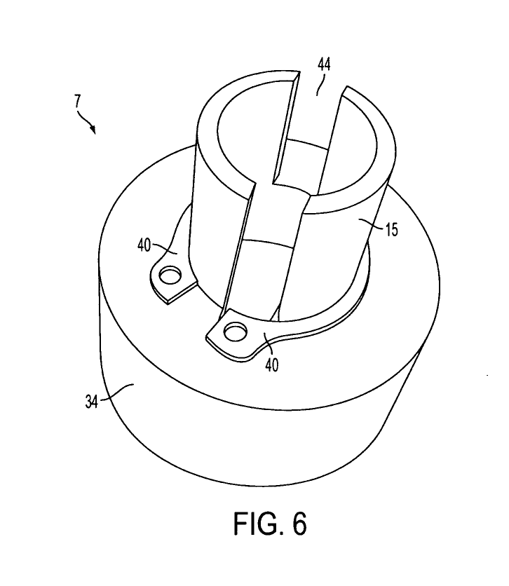

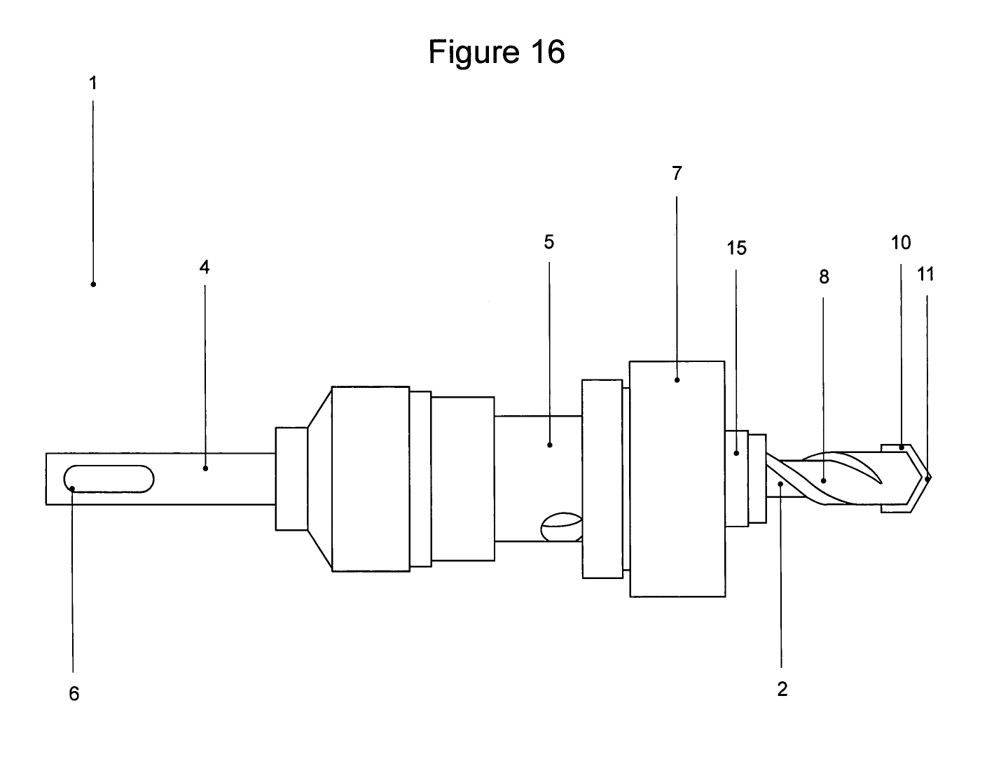

The seismic tool assembly 1 further comprises, with reference to FIG. 16, a stabilizer 7 for receiving, and having mounted thereon, the drill stop member 5. The stabilizer 7 comprises a flange portion 15 constructed and arranged to extend into the drill hole and abut an inside portion thereof. In an alternative embodiment (not shown), the flange portion 15 of the stabilizer 7 could be tapered at a distal end thereof so as to further aid in the accurate and gradual insertion of the seismic drilling bit 2 into the drill hole. In a preferred embodiment, and with reference to FIG. 6, side portions of the flange portion 15 have an elongated opening 44 defined along a length thereof, for allowing passage of the cutting portion of the bit body when the bit body is inserted through the stabilizer 7.

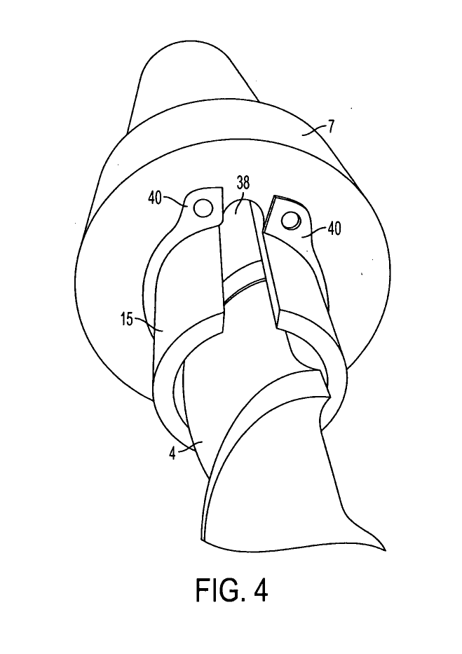

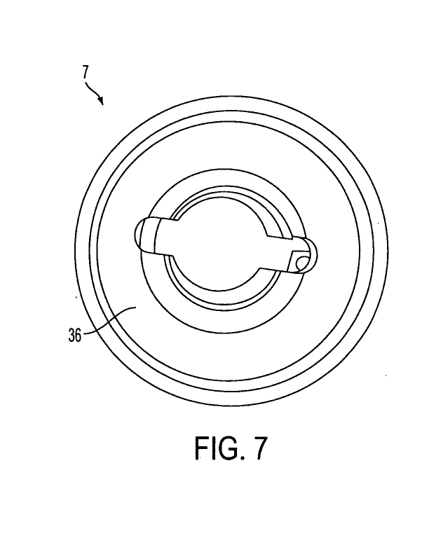

The stabilizer 7 further comprises an upper portion 34 integrally connected to the flange portion 15, the upper portion 34 having, with reference to FIG. 7, a recessed upper surface 36 for receiving the drill stop member 5 mounted thereon. With further reference to FIG. 4, it can be seen that the central opening 38 on the stabilizer 7 has a shape which corresponds substantially to a shape of the cutting portion 10 of the bit body for receiving, and allowing therethrough, the insertion of the seismic drilling bit 2.

Preferably, the stabilizer 7 has the central opening 38 which corresponds with each of the openings of the drill stop member 5 and the drill hole, it being understood that the drill stop member 5 restricts downward drilling movement of the seismic drilling bit 2 into the drill hole to a pre-set depth, through virtue of the bit body 4 of the seismic drilling bit 2 only being able to be pushed downwardly within the drill stop member 5 (mounted on the stabilizer 7) to a certain point, at which it comes into contact with the drill stop member 5, thus restricting its downward movement.

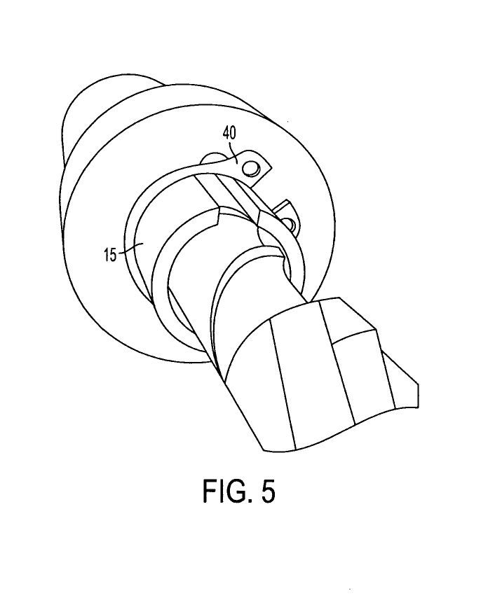

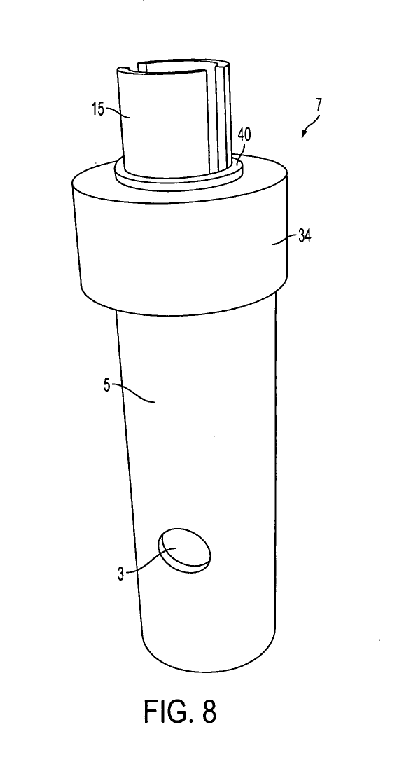

The seismic assembly of the present invention further comprises locking means 40, which are positioned substantially around the flange portion 15 of the stabilizer 7 for selectively stabilizing the seismic drilling bit 2 and for preventing disassembly of the seismic drilling bit 2 from the drill stop member 5 and the stabilizer 7. In a preferred embodiment, the locking means 40 is a substantially circular ring which at least partially encircles an outside of the flange portion 15, the locking means 40 being slidably movable to restrict disengagement of the seismic drilling bit 2 from the stabilizer 7 and the drill stop member 5 mounted thereon. FIG. 4 illustrates the locking means 40 in a substantially open position to receive an insertion of the bit body 2 therethrough, and FIG. 5 illustrates the locking means 40 in a substantially closed position, having been slightly rotated so as to cover the elongated opening 44 in the side portions of the flange portion 15, and thus restrict the disengagement of the bit body 2 from the interconnected drill stop member 5 and stabilizer 7. The interconnection of the stabilizer 7 to the drill stop member 5 can be plainly seen in FIG. 8.

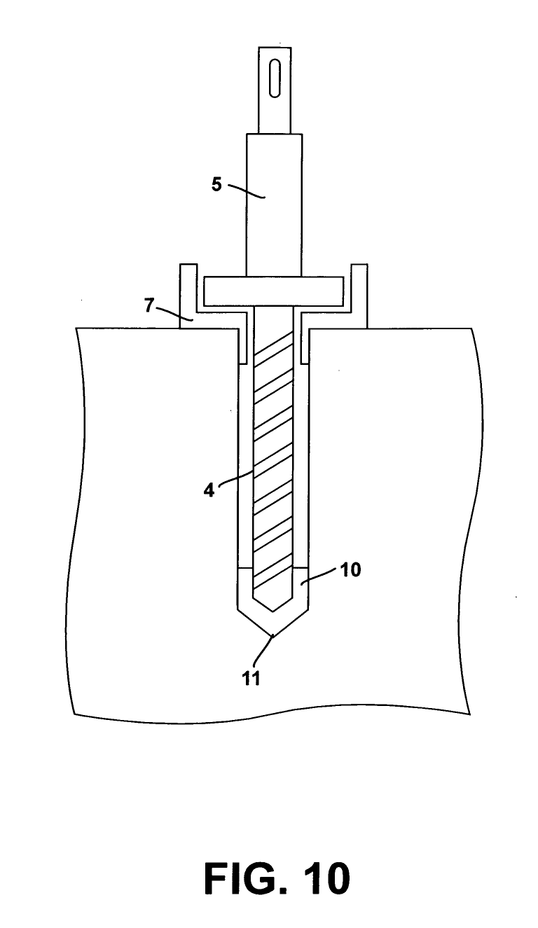

In operation, and as seen in FIG. 10, the drill stop member 5 is mounted upon the stabilizer 7, and the seismic drilling bit 2 is inserted through the openings in the drill stop member 5 and the stabilizer 7. Of course, seismic drilling bit 2 is to be rotatably mounted onto a drill (not shown), and the assembly is positioned over a surface where a drill hole is to be made. Once the seismic drilling bit 2 is sunk to a pre-set depth and rotated, rotational drilling (and tilted rotational drilling as previously described) by the seismic drilling bit 2 can then be effected in creating an enlarged area of the lowermost end of a drill hole.

Of course, by virtue of the cutting portions 10 having an outermost width (and operational cutting radius) that is slightly greater than that of the bit body 4, these cutting portions 10, when the seismic drilling bit 2 is rotated, enlarge a circumference of the drill hole at the lowermost end (in creating the enlarged area) that is greater than that of the remainder of the drill hole. In this manner, once the enlarged area has been created, and the seismic drilling bit 2 removed from the drill hole, the anchor (not shown) can be inserted, and, when the anchors have been flanged outwardly by conventional means within the drill hole, the flange portions of the anchor can rest within the enlarged area, thus securely retaining the anchor in place.

In a still further embodiment (not shown) the bit body 4 of the seismic drilling bit 2 can be tapered, to have a narrower circumference than that of the lowermost end of the bit body. In this manner, the tapered drill bit allows for less physical contact with the drill stop member 5 and increases the range of motion of the seismic drilling bit 2 in permitting limited tilting movement of the bit to enlarge a lowermost end of the drill hole 45. It will also be understood that the seismic drilling bit 2 can come in several set depths, or the drill stop member 5 itself could be adjustable through a locking screw.

In a still further embodiment (not shown), the drill stop member 5 is integrally mounted upon the stabilizer 7, and the seismic drilling bit 2 is inserted through the openings in the drill stop member 5 and the stabilizer 7. In this manner, the drill stop member 5 is permanently connected and un-detachably mounted upon the stabilizer 7, and the seismic drilling bit 2 is permanently inserted through the openings of the drill stop member 5 and the stabilizer 7 so as to be of a permanently connected one-piece construction.

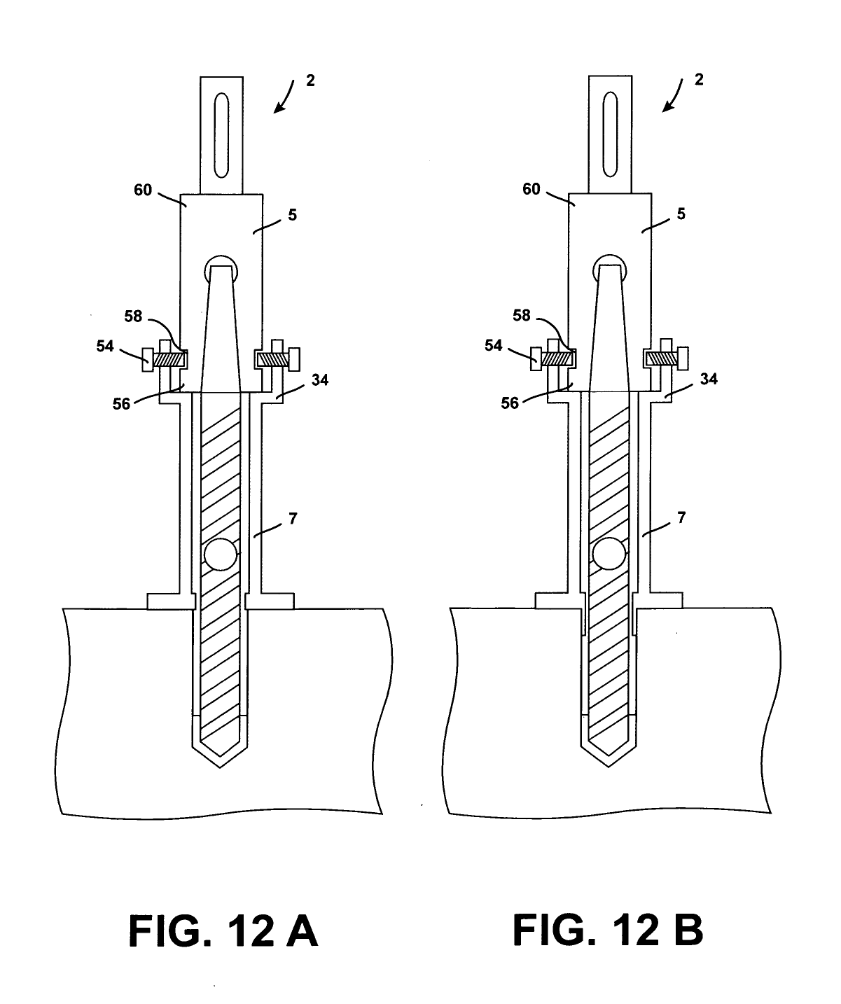

In a still further embodiment of the fully connected seismic tool assembly, shown in FIG. 12B, the drill stop member 5 is mounted upon the stabilizer 7, and the bit body 2 is inserted through the openings in the drill stop member 5 and the stabilizer 7 whereby the drilling of a drill hole can be effected. Of course, it will be understood that the stabilizer 7, when positioned within the drill hole, helps to maintain the integrity of the drill hole by virtue of flange portion 15 (as shown in FIG. 9), which is constructed and arranged to extend into the drill hole 45 and abut an inside portion thereof.

As shown in FIG. 12B, the stabilizer 7 further comprises an upper portion 34. This upper portion 34, as can be seen in FIG. 8, has an outermost width that is greater than that of the flange portion 15. This upper portion 34 receives the drill stop member 5 mounted thereon, as similarly shown in FIG. 8.

In this embodiment, the drill stop member 5 possesses a lower portion 56, a recessed middle portion 58 and an upper portion 60, all of which are, in an exemplary embodiment, integrally connected together, though of course variations to this are possible, as these could potentially be interconnected. As can be seen in FIG. 12B, the lower portion 56 and the upper portion 60 have an outermost width that is substantially equal, while each of the lower portion 56 and the upper portion 60 have an outermost width that is greater than that of the recessed middle portion 58.

In a further embodiment, the upper portion 34 of the stabilizer 7 will have holding screws 54 connected thereto, which are positioned at opposed sides of the upper portion 34 approximately at a same height as the recessed middle portion 58 of the drill stop member 5. These holding screws 54 can either be turned and adjustably moved towards the recessed middle portion 58 of the drill stop member 5 (so as to maintain the connection of the drill stop member 5 to the stabilizer 7 during a drilling process), or adjustably movable away from the recessed middle portion of the drill stop member so as to permit disengagement of the drill stop member from the stabilizer.

Of course, as with the aforementioned embodiment of the seismic tool assembly shown in FIG. 1, the lower end 8 of the bit body 4 has a cutting portion 10 positioned on each side of the lower end 8 of the bit body 4, the cutting portions 10 having a greater outermost width than that of the bit body 4. When the seismic drilling bit is inserted, it creates the drill hole 45 in a one-step process, and it will also be understood that, in a still further embodiment, rotational drilling (and tilted rotational drilling as previously described) by the seismic drilling bit 2 can also be effected in creating an enlarged area of the lowermost end of a drill hole 45, creating a funnel, conical shape in the drill hole 45. In a further embodiment, the bit body 4 can possess a narrower circumference towards a lowermost end of the bit than that of the uppermost end of the bit body. In this manner, the drill bit allows for less physical contact with, particularly, the flange portion 15 of the stabilizer 7 and increases the range of motion of the seismic drilling bit 2, when tilted, to provide a greater range of tilting movement of the bit in enlarging a lowermost end of the drill hole 45.

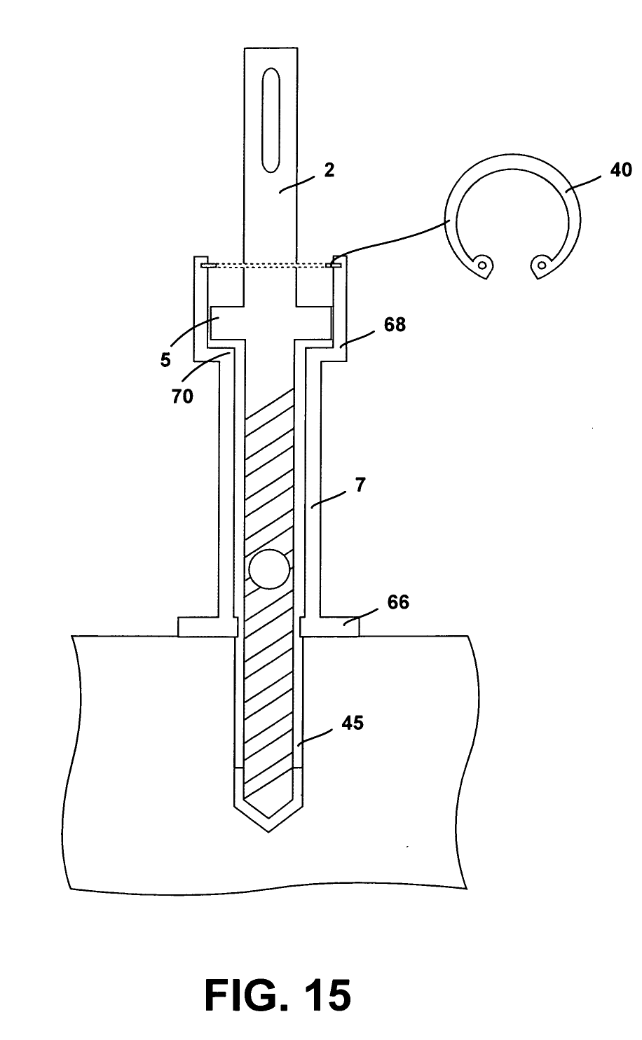

A still further embodiment of the fully connected seismic tool assembly is shown in FIG. 12A. In a similar manner to the embodiment shown in FIG. 15, the drill stop member 5 is mounted within the stabilizer 7, and the bit body 4 is inserted through openings in the drill stop member 5 and the stabilizer 7 whereby the drilling of a drill hole can be effected. In doing so, the drill stop member 5, when in place, abuts an interior portion 70 within the stabilizer 7 so as to inhibit the downward movement of drill stop member 5 within the stabilizer 7, thus restricting the drill bit 4 (surrounded by the drill stop member 5) to achieving a pre-set cutting depth within the drill hole 45. Of course, it will be understood that the stabilizer 7, when positioned, will substantially surround the drill hole 45, and, as shown in FIG. 12A, a lower portion of the stabilizer 7 encircles and surrounds the drill hole 45, the lower portion having a greater outermost width than that of the remainder of the stabilizer 7. It will of course be understood that the dimensions of the stabilizer 7 could be varied, depending upon the size of the drill bit to be used. Unlike the embodiment shown in FIG. 12B, however, tilted rotational drilling of the drill stop member 5 within the stabilizer 7, as shown in FIG. 12A, is not to be effected. Rather, the drill stop member 5 within the stabilizer 7 is rigid and does not have a range of tilted rotation. Instead, when the seismic drilling bit is inserted, it creates the drill hole 45 in a one-step process, and the circumference of the drill hole 45 at the lowermost end thereof is the same circumference of the remainder of the drill hole. Of course, it will also be understood that, in a still further embodiment, rotational drilling (and tilted rotational drilling as previously described) by the seismic drilling bit can also be effected in creating an enlarged area of the lowermost end of a drill hole, in that the drill stop member 5 within the stabilizer 7 is not rigidly retained, so that when the seismic drilling bit is inserted fully into a lowermost end of the drill hole 45 and rotated, the cutting portions 10 enlarge a circumference of the drill hole 45 at the lowermost end thereof that is greater than the circumference of the remainder of the shaft of the drill hole 45.

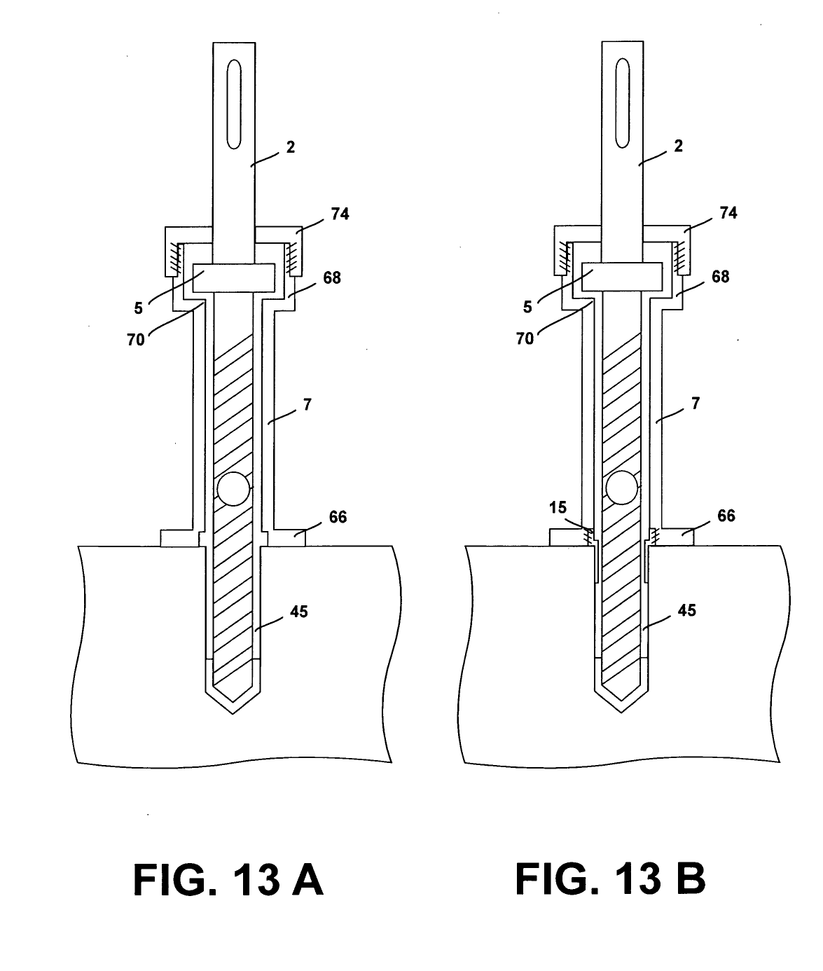

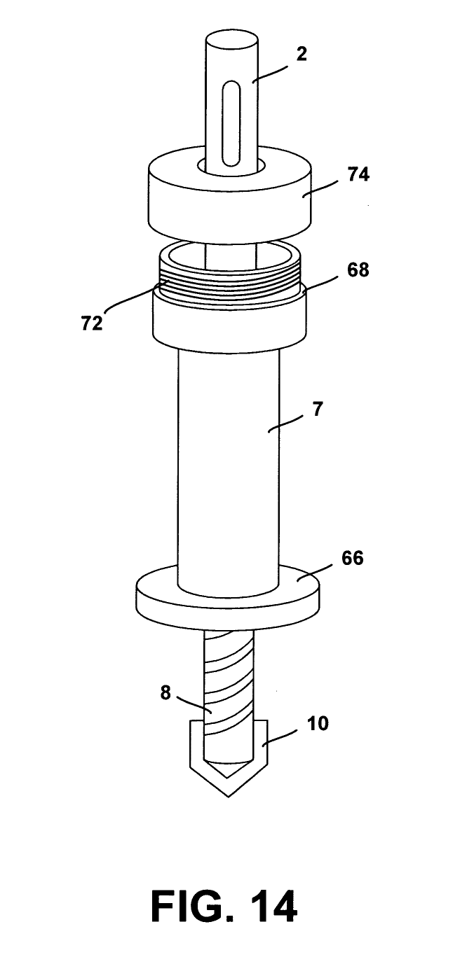

In a still further embodiment of the fully connected seismic tool assembly, shown in FIGS. 13A and 14, the drill stop member 5 is mounted within the stabilizer 7, and the bit body 4 is inserted through openings in the drill stop member 5 and the stabilizer 7 whereby the drilling of a drill hole can be effected. In doing so, the drill stop member 5, when in place, abuts an interior portion 70 within the stabilizer 7 so as to inhibit the downward movement of drill stop member 5 within the stabilizer 7, thus restricting the drill bit (surrounded by the drill stop member 5) to achieving a pre-set cutting depth within the drill hole 45. Of course, it will be understood that the stabilizer 7, when positioned, will substantially surround the drill hole 45, and, as shown in FIG. 13A, a lower portion 66 of the stabilizer 7 encircles and surrounds the drill hole 45, the lower portion having a greater outermost width than that of the remainder of the stabilizer 7. It will of course be understood that the dimensions of the stabilizer could be varied, depending upon the size of the drill bit to be used.

Of course, as with the aforementioned embodiment of the seismic tool assembly shown in FIG. 12A, tilted rotational drilling of the drill stop member 5 within the stabilizer 7 is not to be effected. Rather, the drill stop member 5 within the stabilizer 7 is rigid and does not have a range of tilted rotation. Instead, when the seismic drilling bit is inserted, it creates the drill hole 45 in a one-step process, and the circumference of the drill hole 45 at the lowermost end thereof is the same circumference of the remainder of the drill hole 45.

In an alternative embodiment of the fully connected seismic tool assembly, shown in FIG. 13B, the drill stop member 5 is mounted upon the stabilizer 7, and the bit body 2 is inserted through the openings in the drill stop member 5 and the stabilizer 7 whereby the drilling of a drill hole can be effected. In this embodiment, the stabilizer 7 possesses flange portion 15 (similar to the embodiment shown in FIG. 9), which is constructed and arranged to extend into the drill hole 45 and abut an inside portion thereof. In this embodiment, the lower portion 66 of the stabilizer 7 possesses threads on an interior surface thereof which can be matingly engaged with similar threads contained towards an uppermost end of flange portion 15. When disengagement of the lower portion 66 of the stabilizer 7 and flange portion 15 is desired, the threaded portions of each can be untightened so as to permit disengagement of the flange portion 15 from the stabilizer 7. In this manner, a user can utilize the tilted rotational drilling of the drill stop member 5 within the stabilizer 7, as shown in FIG. 13B, or, simply remove the flange portion 15 with a view to utilizing non-rotational drilling of the drill stop member 5 within the stabilizer 7, as shown in FIG. 13A, whereby the drill stop member 5 within the stabilizer 7 is rigid and does not have a range of tilted rotation. It will be understood that flange portion 15 will serve to limit somewhat the extent to which rotational drilling can be effected, and thus protect the walls of the drill hole 45, as the bit 2 will contact the flange portion 15 if the range of rotation is too great.

Of course, as with the aforementioned embodiment of the seismic tool assembly shown in FIG. 12B, when the seismic drilling bit is inserted, it creates the drill hole 45 in a one-step process, and it will also be understood that, in a still further embodiment, rotational drilling (and tilted rotational drilling as previously described) by the seismic drilling bit body 4 can also be effected in creating an enlarged area of the lowermost end of a drill hole 45, creating a funnel, conical shape in the drill hole 45. In a further embodiment, the bit body 4 can possess a narrower circumference towards a lowermost end of the bit than that of the uppermost end of the bit body. In this manner, the drill bit allows for less physical contact with, particularly, the flange portion 15 of the stabilizer 7 and increases the range of motion of the seismic drilling bit, when tilted, to provide a greater range of tilting movement of the bit in enlarging a lowermost end of the drill hole 45.

As shown in FIGS. 13A, 13B and 14, the stabilizer 7 further comprises an upper portion 68. This upper portion 68, as can be seen in FIG. 14, has an outermost width that is greater than that of the interior portion 70, and posesses threads 72 towards an uppermost end thereof. With reference to FIG. 14, cap portion 74, which also possesses threads on an interior surface thereof (not shown) can be matingly engaged with the threads of upper portion 68 so as to secure the upper portion 68 to the cap portion 74, thus securing the drilling assembly together, in an exemplary embodiment, though of course variations to this are possible. The cap portion will, in an exemplary embodiment, have an opening defined therethrough (not shown) for receiving an insertion of the bit body therethrough, which corresponds with the central opening of the stabilizer 7. When disengagement of the upper portion 68 and cap portion 74 is desired, the threaded portions of each can be untightened so as to permit disengagement of the drill stop member 5 from the stabilizer 7.

In a still further embodiment of the fully connected seismic tool assembly, shown in FIG. 15, the drill stop member 5 is mounted within the stabilizer 7, and the bit body 4 is inserted through openings in the drill stop member 5 and the stabilizer 7 whereby the drilling of a drill hole can be effected. In doing so, the drill stop member 5, when in place, abuts an interior portion 70 within the stabilizer 7 so as to inhibit the downward movement of drill stop member 5 within the stabilizer 7, thus restricting the drill bit (surrounded by the drill stop member 5) to achieving a pre-set cutting depth within the drill hole 45. Of course, it will be understood that the stabilizer 7, when positioned, will substantially surround the drill hole 45, and, as shown in FIGS. 13A and 13B, a lower portion 66 of the stabilizer 7 encircles and surrounds the drill hole 45, the lower portion having a greater outermost width than that of the remainder of the stabilizer 7. It will of course be understood that the dimensions of the stabilizer could be varied, depending upon the size of the drill bit to be used. As with the aforementioned embodiment of the seismic tool assembly shown in FIG. 12A, tilted rotational drilling of the drill stop member 5 within the stabilizer 7 is not to be effected, as previously described. Rather, the drill stop member 5 within the stabilizer 7 is rigid and does not have a range of tilted rotation. Instead, when the seismic drilling bit is inserted, it creates the drill hole 45 in a one-step process, and the circumference of the drill hole 45 at the lowermost end thereof is the same circumference of the remainder of the drill hole 45.

As with the embodiment shown in FIGS. 13A, 13B and 14, the stabilizer 7 further comprises an upper portion 68. However, in this embodiment, the seismic assembly of the present invention further comprises locking means 40, which are positioned substantially around the upper portion 68 of the stabilizer 7 for selectively stabilizing the seismic drilling bit and for preventing, when the locking means are engaged, disassembly of the seismic drilling bit from the drill stop member 5 and the stabilizer 7. In a preferred embodiment, as shown in FIG. 15, the locking means 40 is a substantially circular ring which at least partially encircles the upper portion 68 of the stabilizer 7, the locking means 40 being slidably movable to restrict disengagement of the seismic drilling bit from the stabilizer 7 and the drill stop member 5 mounted thereon.

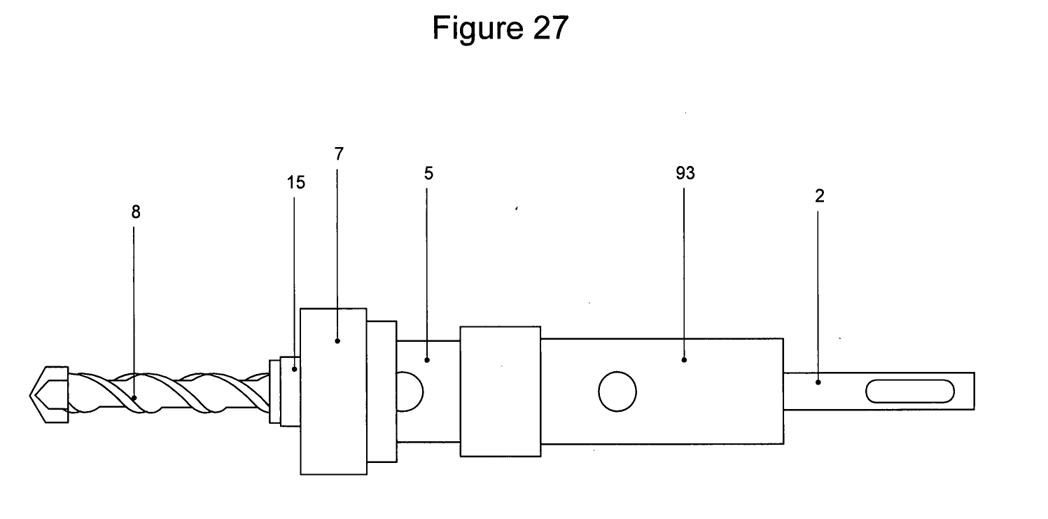

In a still further alternative embodiment of the fully connected seismic tool assembly, shown in FIGS. 16 to 27, referring to FIG. 16, there is shown a seismic tool assembly for use in the later insertion and setting of anchors shown generally at 1 in accordance with a first exemplary embodiment of the present invention. In a preferred embodiment, as hereinafter described, the seismic tool assembly 1 is to be rotatably mounted onto a drill by way of a drill spindle (not shown). It will be understood that there are numerous variations as to the types of attachments to a drill or otherwise that the seismic tool assembly 1 of the present invention could be mounted thereon, as would be readily apparent to one skilled in the art.

In a preferred embodiment, this embodiment of the seismic tool assembly 1 is for use in the later insertion and setting of anchors into concrete, stone, masonry and cementuous materials (though it will be understood that other variations to this are possible) and comprises a seismic drilling bit 2, a stabilizer 7, and a drill stop member 5, as hereinafter described.

Preferably, the components of the assembly, including the seismic drilling bit 2, stabilizer 7, and drill stop member 5, will be made of a durable, machinable metal. The seismic drilling bit 2 is, preferably, is substantially cylindrical in shape and is of a one-piece construction that comprises an upper end 6 and a lower end 8 which are integrally connected to one another.

With reference to FIG. 16, it can be seen that the bit body 4 of the seismic drilling bit 2 can effect the drilling of a drill hole, and has a first diameter (and cutting radius) sized to readily fit into a drill hole (not shown), and possesses, as most conventional drill bits do, at least one cutting edge and at least one groove extending in a helical fashion along a length of the bit body 4 of the seismic drilling bit 2. In a preferred embodiment, these extend along a substantial length of the bit body 4, or, alternatively, extend along at least half a length of the bit body 4. Preferably, the first diameter of the upper end 6 of the bit body 4 is less than or equal to a diameter of the drill hole into which the seismic drilling bit 2 of the present invention is to be inserted.

The upper end 6 of the seismic drilling bit 2 is constructed and arranged to be releasably secured to a drill by way of a drill spindle (not shown). In an exemplary embodiment, the distal lower end 8 of the seismic drilling bit 2 has a drill tip 11 extending generally outwardly from the lower end 8.

The lower end 8 of the seismic drilling bit 2 has a cutting portion 10 positioned on each side of the lower end 8 of the seismic drilling bit 2, the cutting portions 10 having a greater outermost width than that of the bit body 4 whereby, when the seismic drilling bit 2 is inserted fully into an lowermost end of the drill hole and rotated, the cutting portions 10 enlarge a circumference of the drill hole at the lowermost end thereof that is greater than the circumference of the remainder of the shaft of the drill hole. Preferably, the cutting portions 10 extend outwardly from substantially around an entirety of the lower end 8 of the seismic drilling bit 2, as seen in FIG. 16. In an alternative embodiment (which is not shown), the lower end 8 of the seismic drilling bit 2 can have a cutting portion positioned on only one side of the lower end 8 of the seismic drilling bit 2.

In a still further embodiment (not shown), the bit body 4 of the seismic drilling bit 2 has a diameter (and cutting radius) that is less than that of the drill hole, with the cutting portions 10, of course, still having a greater outermost width (and cutting radius) than that of the bit body 4. In this manner, with the bit body 4 of the seismic drilling bit 2 having a width that is less than that of the drill hole, the initial insertion of the seismic drilling bit 2 into the drill hole is made easier, whereby the bit does not need to be as readily forcibly inserted.

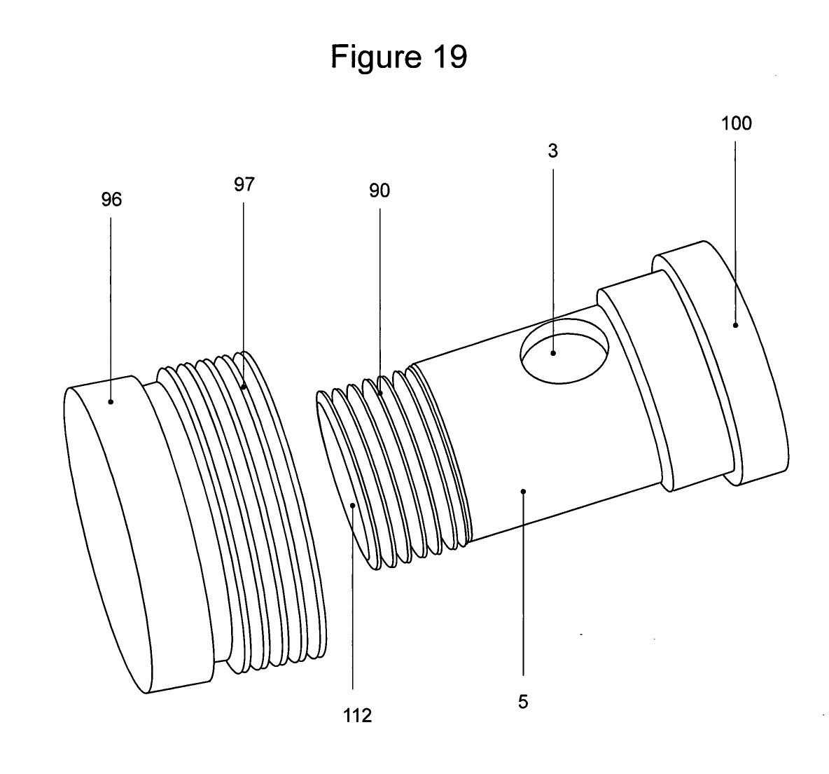

With reference to FIG. 19, the drill stop member 5, preferably, has an opening 112 defined therethrough, and is used for receiving an insertion of the seismic drilling bit 2. Preferably, the opening 112 in the drill stop member 5 is positioned at a substantially central location of the drill stop member 5. The drill stop member 5 aids in the accurate and gradual insertion of the seismic drilling bit 2 into the drill hole. The drill stop member 5 further comprises, with reference to FIG. 19, a dust exit opening 3 defined therein for allowing dust to be removed from the assembly during the drilling process, the dust exit opening 3 being positioned at substantially a middle portion of the drill stop member 5. It will, of course, also be understood that the stabilizer 7 could also possess such a dust exit opening.

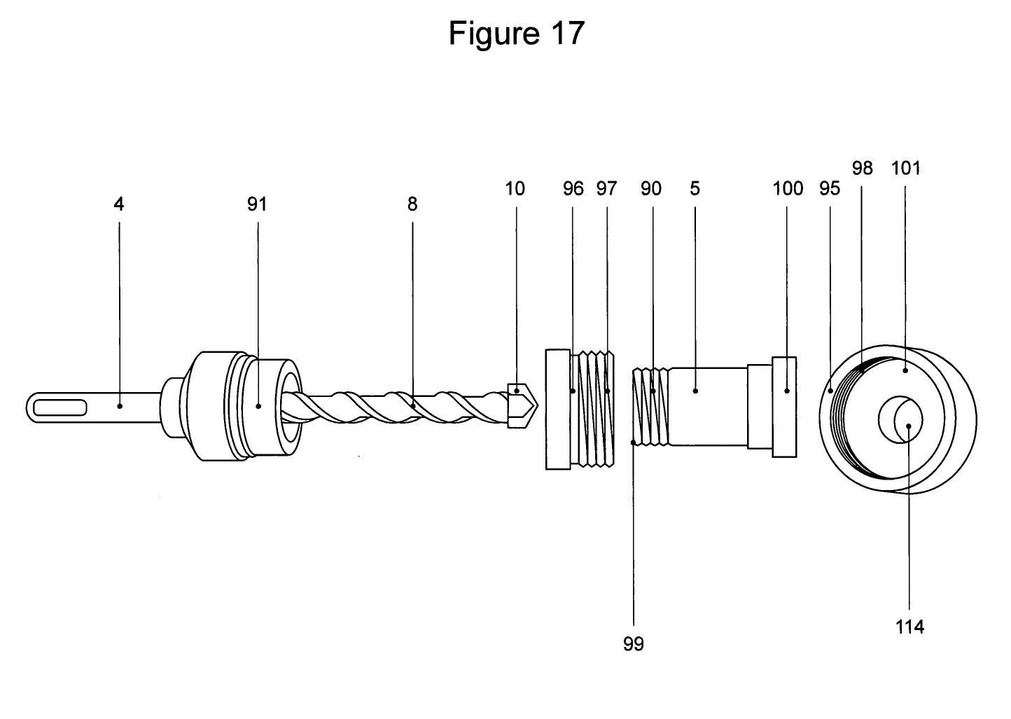

The seismic tool assembly 1 further comprises, with reference to FIGS. 19 to 21, a stabilizer 7 for receiving, and having mounted thereon, the drill stop member 5. The stabilizer 7 comprises a flange portion 15 constructed and arranged to extend into the drill hole and abut an inside portion thereof. In an alternative embodiment (not shown), the flange portion 15 of the stabilizer 7 could be tapered at a distal end thereof so as to further aid in the accurate and gradual insertion of the seismic drilling bit 2 into the drill hole. It will of course be understood that the dimensions of the stabilizer 7, or indeed of any of the components of the assembly 1 could be varied, depending upon the size of the drill bit to be used. In an exemplary embodiment, the stabilizer 7, with reference to FIG. 17, has a central opening 114 which corresponds with each of the openings of the drill stop member 5 and the drill hole. The flange portion 15 when drilling acts also to stabilize the drill hole, as the flange portion 15 is bigger that the borehole, and, when forced inside when drilling, it becomes a controlled and secure tilted rotation as it jams up the borehole.

The opening 114 on the stabilizer 7 has a diameter larger than the cutting portions 10 of the bit body 4. By virtue of the opening 114 being greater than the cutting portions 10 of the bit body 4 to accommodates passage therethrough, this allows the insertion of the seismic drilling bit 2 into the drill hole (not shown), and permits a controlled limited tilting movement of the bit body 4 from its vertical axis within the opening 114 (and allows for less physical contact with, particularly, the flange portion 15) on the stabilizer 7 during the drilling process to further enlarge a lowermost end of the drill hole, it being understood that this tilting rotational drilling of the lower end of the drill hole by the drill bit 2 within the opening 114 can be done through 360 degrees, whereby the lower end of the drill hole can be made to be conical and funnel-shaped, for receiving anchors therein. It will also be understood that to reduce or increase the conical effect of the bore hole the drill stop member 5 can be machined to be smaller or bigger, as required. Further, the drill stop member 5 can be interchanged to accommodate different drilling depths and sizes of drill bits.

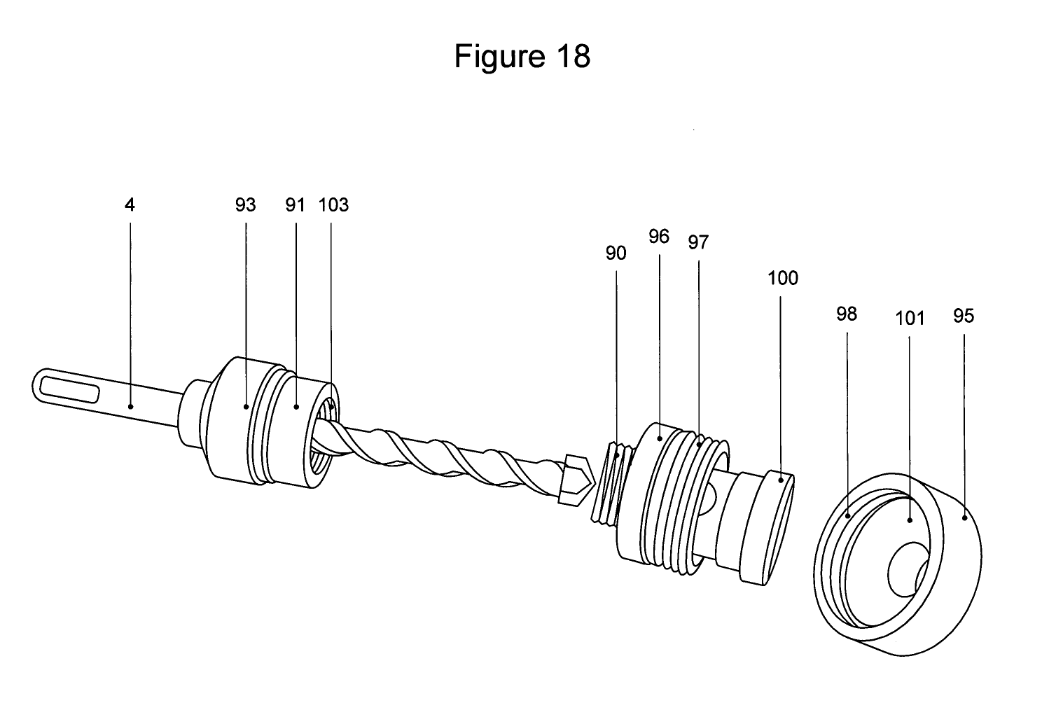

The stabilizer 7 further comprises, as shown in FIGS. 17 and 18, the stabilizer 7 is comprised of a lower portion 95 and a securing portion 96, which possesses threads 97 towards a lowermost end thereof. In an exemplary embodiment, each of the lower portion 95 and a securing portion 96 comprise openings therethrough which corresponds with each of the openings of the drill stop member 5 and the drill hole. In positioning the drill stop member 5 within the assembly, an upper end 99 of the drill stop member 5 is passed through an opening in the securing portion 96, and a lower end 100 is then positioned within the lower portion 95, the lower end 100 resting on abutment region 101. The lower end 100 of drill stop member 5, when in place, abuts abutment region 101 so as to inhibit the downward movement of drill stop member 5 within the lower portion 95. To secure the drill stop member 5 in place, the lower portion 95 possesses threads on an interior surface thereof 98 which can be matingly engaged with the threads 97 of securing portion 96 so as to secure the lower portion 95 to the securing portion 96, and each of the lower portion 95 and securing portion 96 have an outermost width that is greater than that of the drill stop member 5. In this manner, once the lower portion 95 and securing portion 96 are secured together, the lower portion 95 and securing portion 96 hold the lower end 100 of the drill stop member 5 firmly in place within the assembly.

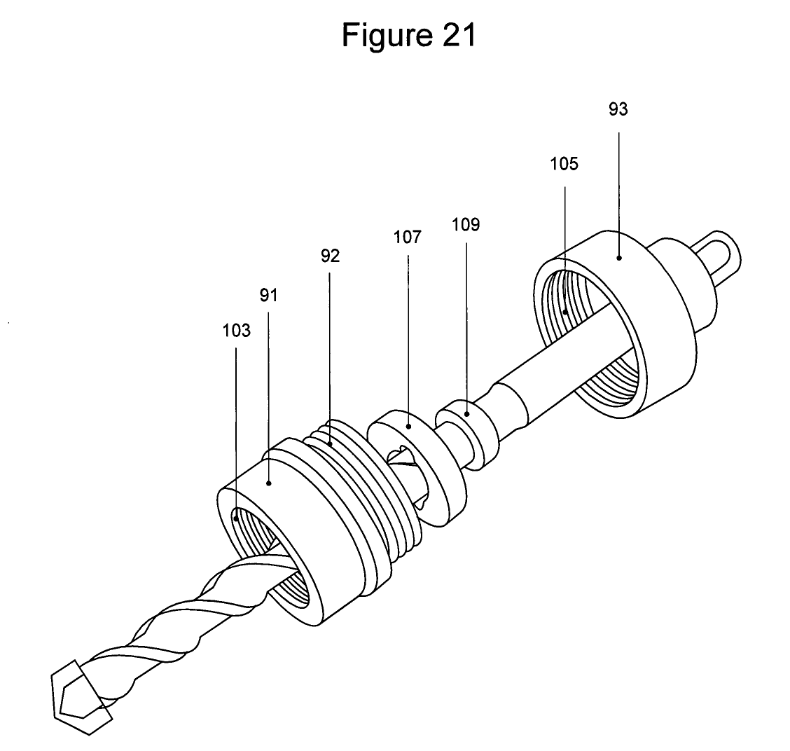

To secure the upper end of the assembly 1 in place, as shown in FIGS. 16, 17, 18 and 19, the drill stop member 5 itself possesses threads 90 towards an uppermost end 99 thereof. The drill stop member 5 further comprises an upper portion 91. This upper portion 91, also possesses threads 103 on an interior surface thereof (shown in FIG. 21) which can be matingly engaged with the threads 90 on uppermost end 99 of the drill stop member 5 so as to secure the upper portion 91 to the drill stop member 5, though of course variations to this are possible.

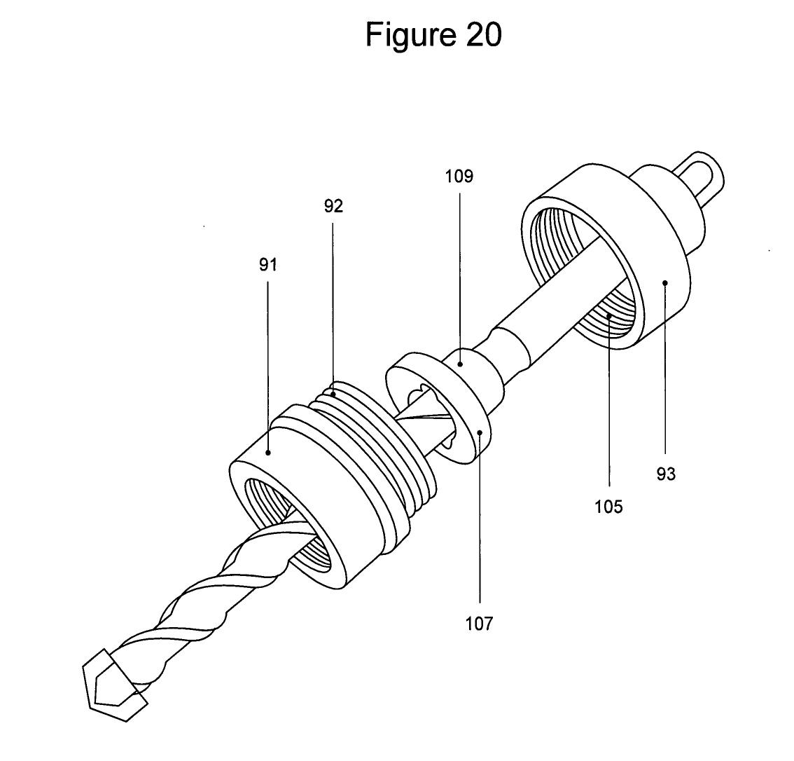

In turn, as shown in FIGS. 20 and 21, the upper portion 91 also possesses threads 92 towards an uppermost end thereof, which can be matingly engaged with cap portion 93, which also possesses threads 105 on an interior surface thereof. The cap portion 93 and upper portion 91 will, in an exemplary embodiment, each have an opening defined therethrough (not shown) for receiving an insertion of the bit body 4 therethrough, which corresponds with the central openings of the stabilizer 7 and the drill stop member 5. In this manner, once upper portion 91 is connected to the drill stop member 5, and the cap portion 93 is also secured to the opposite end of upper portion 91, these hold the upper end of the drill stop member 5 firmly in place within the assembly. When disengagement of the upper portion 91 and cap portion 93 is desired, the threaded portions of each can be untightened so as to permit the disengagement of components from the drill stop member 5.

FIGS. 20 and 21 illustrate the seismic drill bit 2 having abutment member 109 thereon, and the assembly further comprising restrictive disk 107, the restrictive disk 107 being operably able to be positioned within an upper end of the upper portion 91, and to cover substantially the upper end of the upper portion 91. In an exemplary embodiment, the restrictive disk 107 has a shape which corresponds substantially to a shape of the cutting portions 10 of the seismic drill bit 2 for receiving the insertion of the seismic drill bit 2 therethrough.

When the seismic drill bit 2 is inserted through the upper end of the upper portion 91, the restrictive disk 107 restricts downward movement of the seismic drilling bit 2 to a pre-set depth, through virtue of the seismic drilling bit 2 only being able to be pushed downwardly within the upper portion 91 to a certain point, at which abutment member 109 it comes into contact with the restrictive disk 107, thus restricting downward movement of the seismic drilling bit 2.

In operation the seismic drill bit 2 is inserted through the upper end of the upper portion 91, whereby the restrictive disk 107 restricts downward movement of the seismic drilling bit 2 to a pre-set depth, through virtue of the seismic drilling bit 2 only being able to be pushed downwardly within the upper portion 91 to a certain point, at which abutment member 109 comes into contact with the restrictive disk 107 within an upper end of the upper portion 91, thus restricting downward movement of the seismic drilling bit 2.

An upper end 99 of the drill stop member 5 is then passed through an opening in the securing portion 96, and a lower end 100 is then positioned within the lower portion 95, the lower end 100 resting on abutment region 101. The lower end 100 of drill stop member 5, when in place, abuts abutment region 101 so as to inhibit the downward movement of drill stop member 5 within the lower portion 95. Once this is done the seismic drilling bit 2 is then inserted downwardly through the openings in each of the securing portion 96, the drill stop member 5 and the lower portion 95. Of course, the lower end 8 of the seismic drilling bit 2 emerges through opening 114 in the lower portion 95.

To secure the drill stop member 5 in place, and the lower end of the assembly 1 in place, the lower portion 95 possesses threads on an interior surface thereof 98 (see FIGS. 17 and 18) which can be matingly engaged with the threads 97 of securing portion 96 so as to secure the lower portion 95 to the securing portion 96, and each of the lower portion 95 and securing portion 96 have an outermost width that is greater than that of the drill stop member 5. In this manner, once the lower portion 95 and securing portion 96 are secured together, the lower portion 95 and securing portion 96 hold the lower end 100 of the drill stop member 5 firmly in place within the assembly.

To secure the upper end of the assembly 1 in place the threads 90 of the drill stop member 5 are matingly engaged with the threads 103 of the upper portion 91 (see FIGS. 18 and 21). The upper end 6 of the seismic drilling bit 2 is then inserted through the opening in the cap portion 93, and the cap portion is then moved downwardly, whereby the threads 92 of the upper portion 91 can be matingly engaged with the threads 105 on an interior surface of the cap portion 93 to secure the upper half the assembly. The drilling process is then begun, in a one-step process, whereby the drill hole is first created, then, as downward pressure is continued, the flange portion 15 of the stabilizer 7 is pushed to extend into the drill hole and abut an inside portion thereof. In this manner, the flange portion 15 stabilizes the seismic tool assembly 1 during the drilling process. Once the seismic drilling bit 2 is sunk to a pre-set depth and rotated, rotational drilling (and tilted rotational drilling as previously described) by the seismic drilling bit 2 can then be effected in creating an enlarged area of the lowermost end of a drill hole.

Of course, by virtue of the cutting portions 10 having an outermost width (and operational cutting radius) that is slightly greater than that of the bit body 4, these cutting portions 10, when the seismic drilling bit 2 is rotated, enlarge a circumference of the drill hole at the lowermost end (in creating the enlarged area) that is greater than that of the remainder of the drill hole. In this manner, once the enlarged area has been created, and the seismic drilling bit 2 removed from the drill hole, the anchor (not shown) can be inserted, and, when the anchors have been flanged outwardly by conventional means within the drill hole, the flange portions of the anchor can rest within the enlarged area, thus securely retaining the anchor in place.

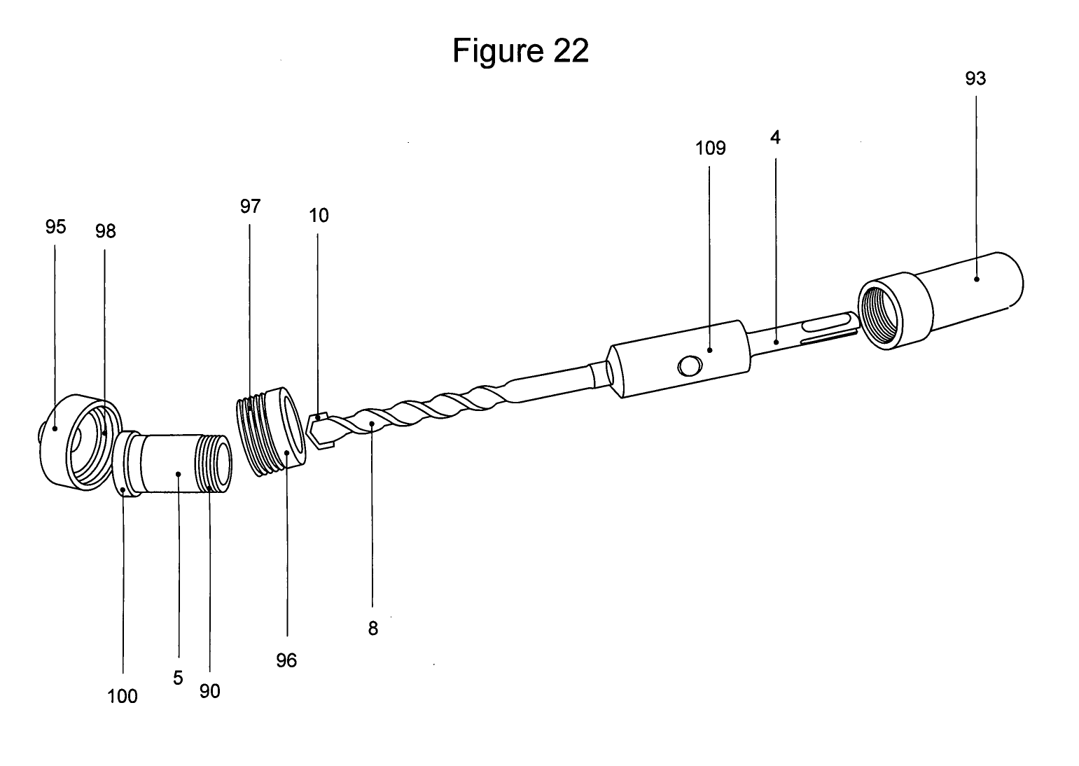

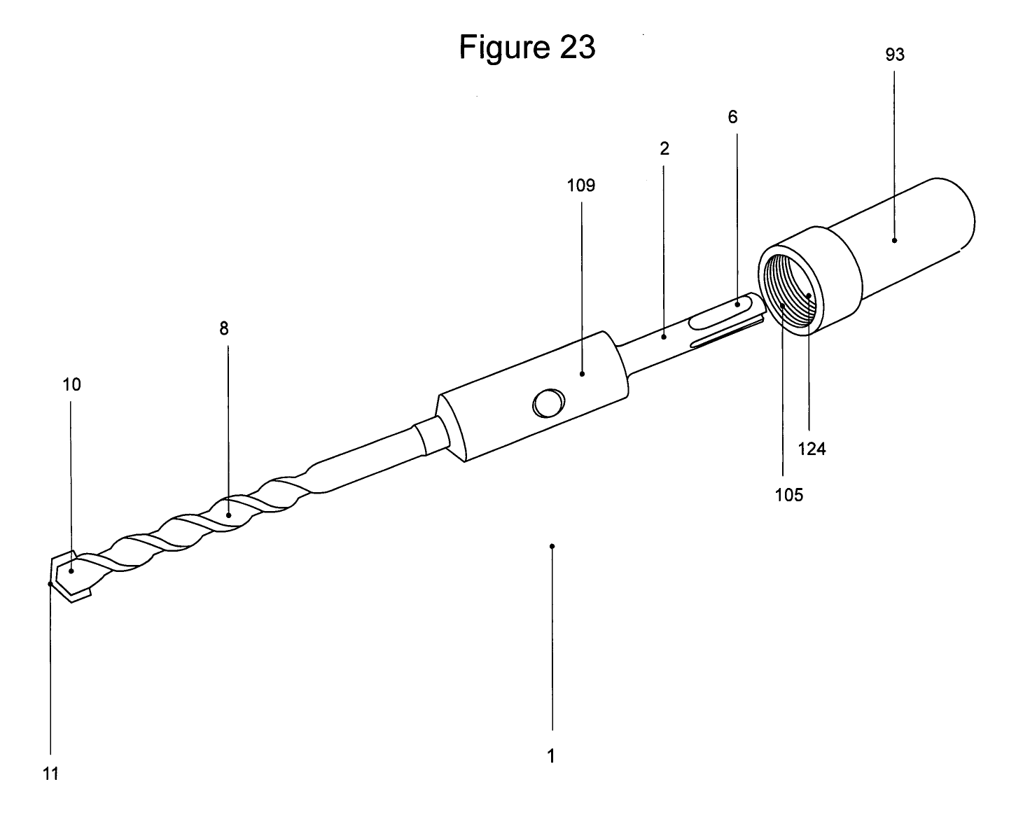

In a still further alternative embodiment of the fully connected seismic tool assembly, shown in FIGS. 22 to 27, there is shown a seismic tool assembly for use in the later insertion and setting of anchors shown generally at 1 in accordance with a first exemplary embodiment of the present invention. As previously described with other embodiments, the seismic tool assembly 1, as shown in FIG. 23, is to be rotatably mounted onto a drill by way of a drill spindle (not shown).

In a preferred embodiment, this embodiment of the seismic tool assembly 1 is for use in the later insertion and setting of anchors into concrete, stone, masonry and cementuous materials (though it will be understood that other variations to this are possible) and comprises a seismic drilling bit 2, a stabilizer 7, a drill stop member 5 and a cap portion 93, as hereinafter described.

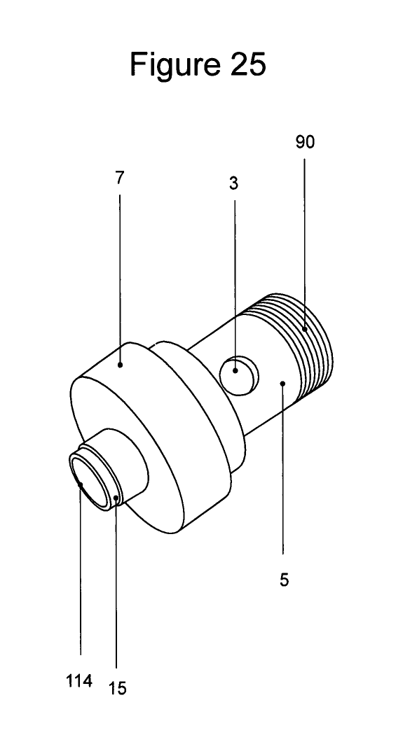

Preferably, the components of the assembly, including the seismic drilling bit 2 (see FIG. 23), stabilizer 7 (see FIG. 25), and drill stop member 5 (see FIG. 22), will be made of a durable, machinable metal. The seismic drilling bit 2 is, preferably, substantially cylindrical in shape and is of a one-piece construction that comprises an upper end 6 and a lower end 8 which are integrally connected to one another.

With reference to FIG. 22, it can be seen that the bit body 4 of the seismic drilling bit 2 can effect the drilling of a drill hole, and has a first diameter (and cutting radius) sized to readily fit into a drill hole (not shown), and possesses, as most conventional drill bits do, at least one cutting edge and at least one groove extending in a helical fashion along a length of the bit body 4 of the seismic drilling bit 2. In a preferred embodiment, these extend along a substantial length of the bit body 4, or, alternatively, extend along at least half a length of the bit body 4. Preferably, the first diameter of the upper end 6 of the bit body 4 is less than or equal to a diameter of the drill hole into which the seismic drilling bit 2 of the present invention is to be inserted.

The upper end 6 of the seismic drilling bit 2, with reference to FIG. 23, is constructed and arranged to be releasably secured to a drill by way of a drill spindle (not shown). In an exemplary embodiment, the distal lower end 8 of the seismic drilling bit 2 has a drill tip 11 extending generally outwardly from the lower end 8.

The lower end 8 of the seismic drilling bit 2 has a cutting portion 10 positioned on each side of the lower end 8 of the seismic drilling bit 2, the cutting portions 10 having a greater outermost width than that of the bit body 4 whereby, when the seismic drilling bit 2 is inserted fully into a lowermost end of the drill hole and rotated, the cutting portions 10 enlarge a circumference of the drill hole at the lowermost end thereof that is greater than the circumference of the remainder of the shaft of the drill hole. Preferably, the cutting portions 10 extend outwardly from substantially around an entirety of the lower end 8 of the seismic drilling bit 2, as seen in FIG. 23. In an alternative embodiment (which is not shown), the lower end 8 of the seismic drilling bit 2 can have a cutting portion positioned on only one side of the lower end 8 of the seismic drilling bit 2.

In a still further embodiment (not shown), the bit body 4 of the seismic drilling bit 2 has a diameter (and cutting radius) that is less than that of the drill hole, with the cutting portions 10, of course, still having a greater outermost width (and cutting radius) than that of the bit body 4. In this manner, with the bit body 4 of the seismic drilling bit 2 having a width that is less than that of the drill hole, the initial insertion of the seismic drilling bit 2 into the drill hole is made easier, whereby the bit does not need to be as readily forcibly inserted.

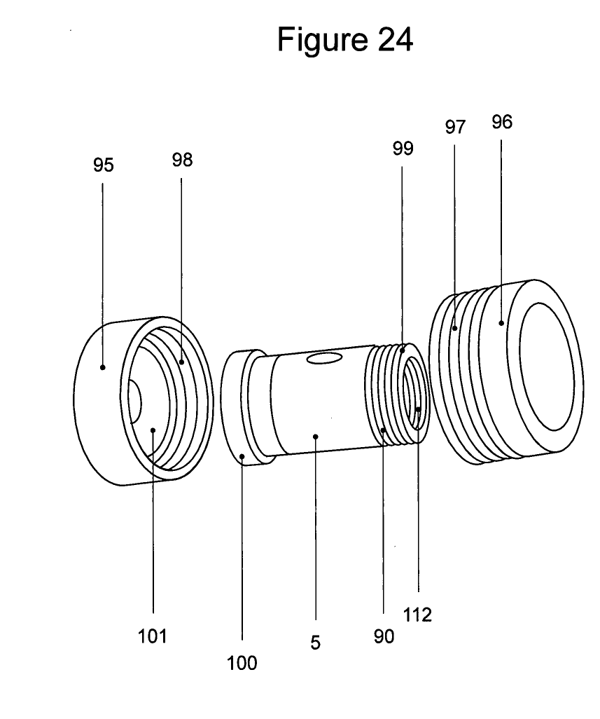

With reference to FIG. 24, the drill stop member 5, preferably, has an opening 112 defined therethrough, and is used for receiving an insertion of the seismic drilling bit 2. Preferably, the opening 112 in the drill stop member 5 is positioned at a substantially central location of the drill stop member 5. The drill stop member 5 aids in the accurate and gradual insertion of the seismic drilling bit 2 into the drill hole. The drill stop member 5 further comprises, with reference to FIG. 25, a dust exit opening 3 defined therein for allowing dust to be removed from the assembly during the drilling process, the dust exit opening 3 being positioned at substantially a middle portion of the drill stop member 5. It will, of course, also be understood that the stabilizer 7 could also possess such a dust exit opening.

The seismic tool assembly 1 further comprises, with reference to FIGS. 22 to 27, a stabilizer 7 for receiving, and having mounted thereon, the drill stop member 5. The stabilizer 7 comprises a flange portion 15 constructed and arranged to extend into the drill hole and abut an inside portion thereof. In an alternative embodiment (not shown), the flange portion 15 of the stabilizer 7 could be tapered at a distal end thereof so as to further aid in the accurate and gradual insertion of the seismic drilling bit 2 into the drill hole. It will of course be understood that the dimensions of the stabilizer 7, or indeed of any of the components of the assembly 1 could be varied, depending upon the size of the drill bit to be used. In an exemplary embodiment, the stabilizer 7, with reference to FIG. 25, has a central opening 114 which corresponds with each of the openings of the drill stop member 5 and the drill hole.

With further reference to FIG. 25, it can be seen that the opening 114 on the stabilizer 7 has a diameter larger than the cutting portions 10 of the bit body 4. By virtue of the opening 114 being greater than the cutting portions 10 of the bit body 4 to accommodates passage therethrough, this allows the insertion of the seismic drilling bit 2 into the drill hole (not shown), and permits limited tilting movement of the bit body 4 from its vertical axis within the opening 114 (and allows for less physical contact with, particularly, the flange portion 15) on the stabilizer 7 during the drilling process to further enlarge a lowermost end of the drill hole, it being understood that this tilting rotational drilling of the lower end of the drill hole by the drill bit 2 within the opening 114 can be done through 360 degrees, whereby the lower end of the drill hole can be made to be conical and funnel-shaped, for receiving anchors therein.

The stabilizer 7 further comprises, as shown in FIG. 24, the stabilizer 7 is comprised of a lower portion 95 and a securing portion 96, which possesses threads 97 towards a lowermost end thereof. In an exemplary embodiment, each of the lower portion 95 and a securing portion 96 comprise openings therethrough which corresponds with each of the openings of the drill stop member 5 and the drill hole. In positioning the drill stop member 5 within the assembly, an upper end 99 of the drill stop member 5 is passed through an opening in the securing portion 96, and a lower end 100 of the drill stop member 5 is then positioned within the lower portion 95, the lower end 100 resting on abutment region 101. The lower end 100 of drill stop member 5, when in place, abuts abutment region 101 so as to inhibit the downward movement of drill stop member 5 within the lower portion 95. To secure the drill stop member 5 in place, the lower portion 95 possesses threads on an interior surface thereof 98 which can be matingly engaged with the threads 97 of securing portion 96 so as to secure the lower portion 95 to the securing portion 96, and each of the lower portion 95 and securing portion 96 have an outermost width that is greater than that of the drill stop member 5. In this manner, once the lower portion 95 and securing portion 96 are secured together, the lower portion 95 and securing portion 96 hold the lower end 100 of the drill stop member 5 firmly in place within the assembly.

FIGS. 23, 24 and 26 illustrate the seismic drill bit 2 having abutment member 109 thereon, the abutment member 109 having a greater width than a remainder of the seismic drill bit 2. When the seismic drill bit 2 is inserted through the uppermost end 99 of the drill stop member 5, and as the seismic drill bit 2 continues to be inserted therethrough, abutment member 109 on the seismic drilling bit 2 eventually comes into contact with the uppermost end 99 of the drill stop member 5, thus restricting downward movement of the seismic drilling bit 2 to a pre-set depth.

To secure the upper end of the assembly 1 in place, as shown in FIGS. 24, 26 and 27, the drill stop member 5 itself possesses threads 90 towards an uppermost end 99 thereof, which can be matingly engaged with cap portion 93, which also possesses threads 105 on an interior surface thereof. The cap portion 93, as shown in FIG. 23, will, in an exemplary embodiment, have an opening 124 (see FIG. 23) defined therethrough for receiving an insertion of the seismic drill bit 2 therethrough, which corresponds with the central openings of the stabilizer 7 and the drill stop member 5. The cap portion 93 is positioned over the distal end 6 of the seismic drilling bit 2, and the cap portion 93 is then moved downwardly to cover and surround a substantial middle portion of the seismic drilling bit 2, whereby the threads 105 on an interior surface of the cap portion 93 (see FIG. 23) can then be matingly engaged with the threads 90 of the drill stop member 5 to secure the upper half the assembly. When disengagement of the drill stop member 5 and cap portion 93 is desired, the threaded portions of each can be untightened so as to permit the disengagement of components.

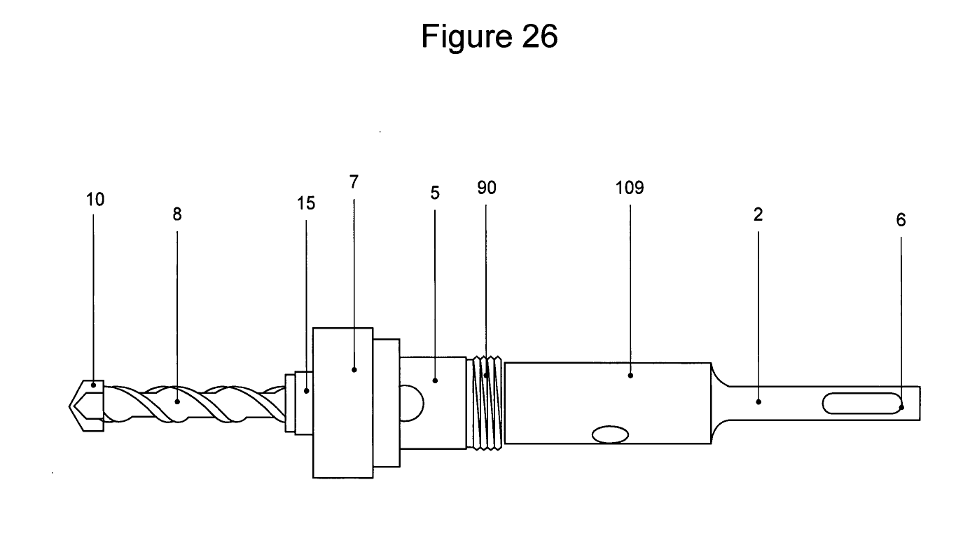

In operation the seismic drill bit 2 is inserted through the uppermost end 99 of the drill stop member 5, whereby, as seismic drill bit 2 continues to be inserted therethrough, abutment member 109 on the seismic drilling bit 2 comes into contact with the uppermost end 99 of the drill stop member 5, thus restricting downward movement of the seismic drilling bit 2 to a pre-set depth, see FIGS. 24 and 26, which illustrates that the uppermost end 99 of the drill stop member 5 and the abutment member 109 on the seismic drilling bit 2 have a width that is substantially equal.

A lower end 100 of the drill stop member 5 is then positioned within the lower portion 95, the lower end 100 resting on abutment region 101. The lower end 100 of drill stop member 5, when in place, abuts abutment region 101 so as to inhibit the downward movement of drill stop member 5 within the lower portion 95. Once this is done the seismic drilling bit 2 is then inserted downwardly through the openings in each of the securing portion 96, the drill stop member 5 and the lower portion 95. Of course, the lower end 8 of the seismic drilling bit 2 emerges through opening 114 in the lower portion 95.

To secure the drill stop member 5 in place, and the lower end of the assembly 1 in place, the lower portion 95 possesses threads on an interior surface thereof 98 which can be matingly engaged with the threads 97 of securing portion 96 so as to secure the lower portion 95 to the securing portion 96, and each of the lower portion 95 and securing portion 96 have an outermost width that is greater than that of the drill stop member 5. In this manner, once the lower portion 95 and securing portion 96 are secured together, the lower portion 95 and securing portion 96 hold the lower end 100 of the drill stop member 5 firmly in place within the assembly, as shown in FIG. 26.

To secure the upper end of the assembly 1 in place, a cap portion 93 having an opening defined therethrough is positioned over the distal end 6 of the seismic drilling bit 2, and the cap portion 93 is then moved downwardly to cover and surround a substantial middle portion of the seismic drilling bit, whereby the threads 105 on an interior surface of the cap portion 93 (see FIG. 23) can be matingly engaged with the threads 90 of the drill stop member 5 to secure the upper half the assembly, as shown in FIG. 26. The drilling process is then begun, in a one-step process, whereby the drill hole is first created, then, as downward pressure is continued, the flange portion 15 of the stabilizer 7 is pushed to extend into the drill hole and abut an inside portion thereof. In this manner, the flange portion 15 stabilizes the seismic tool assembly 1 during the drilling process. Once the seismic drilling bit 2 is sunk to a pre-set depth and rotated, rotational drilling (and tilted rotational drilling as previously described) by the seismic drilling bit 2 can then be effected in creating an enlarged area of the lowermost end of a drill hole.

Of course, by virtue of the cutting portions 10 having an outermost width (and operational cutting radius) that is slightly greater than that of the bit body 4, these cutting portions 10, when the seismic drilling bit 2 is rotated, enlarge a circumference of the drill hole at the lowermost end (in creating the enlarged area) that is greater than that of the remainder of the drill hole. In this manner, once the enlarged area has been created, and the seismic drilling bit 2 removed from the drill hole, the anchor (not shown) can be inserted, and, when the anchors have been flanged outwardly by conventional means within the drill hole, the flange portions of the anchor can rest within the enlarged area, thus securely retaining the anchor in place.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

The embodiments of the invention in which an exclusive property or privilege is claimed are defined as follows:

1. A seismic tool assembly for effecting a drill hole and enlarging a lowermost end thereof for a later insertion and setting of anchors therein, the assembly comprising:
a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body;
a drill stop member having an opening defined therethrough corresponding with the drill hole and for receiving an insertion of the bit body therethrough;
a restrictive disk for substantially covering an upper surface of the drill stop member and having an opening defined therethrough corresponding with the drill hole and for receiving an insertion of the bit body therethrough;
a stabilizer for mounting within at least a portion of the drill hole and having a recessed interior portion which is constructed and arranged for having the drill stop member mounted thereon, the stabilizer further comprising:
(a) a flange portion constructed and arranged to extend into the drill hole and abut an inside portion thereof;
(b) a central opening corresponding with the opening of the drill stop member, the central opening providing a space between the bit body and the flange portion to permit limited tilting movement of the bit body during a drilling process to enlarge the lowermost end of the drill hole;
(a) a threaded portion on an upper interior surface of the stabilizer;
(b) a securing portion having an opening defined therethrough for receiving an insertion of the bit body therethrough, and corresponding with the central opening of the stabilizer, a lower end of the securing portion being threaded so as to permit threaded engagement of the securing portion to the threaded portion of the stabilizer so as to prevent disengagement of the drill stop member from the stabilizer during the drilling process.

1. The assembly as claimed in claim 1, wherein the cutting portion extends outwardly from substantially around an entirety of the second end region.

2. The assembly as claimed in claim 1, wherein the drill bit is constructed and arranged for attachment to a power drill.

3. The assembly of claim 1, wherein the second end region of the drill bit has a tapered end and a drill tip extending generally outwardly from the tapered end.

4. The assembly of claim 1, wherein the opening in the stabilizer is positioned at a substantially central location of the stabilizer.

5. The assembly of claim 1, wherein the restrictive disk has a shape which corresponds substantially to a shape of the cutting portion of the bit body to permit receiving an insertion of the bit body therethrough.

6. The assembly of claim 1, wherein the drill stop member further comprises a dust exit opening defined therein for allowing dust to be removed from the assembly during the drilling process, the dust exit opening being positioned at substantially a middle portion of the drill stop member.

7. The assembly of claim 1, wherein the opening on the stabilizer has a diameter greater than a diameter of the cutting portion of the bit body, the opening providing a space between the bit body and the stabilizer to permit a greater range of tilting movement of the bit body to enlarge the lowermost end of the drill hole.

9. The assembly of claim 1, wherein the drill stop member further comprises threads on an uppermost end thereof.

10. The assembly of claim 9, wherein the drill stop member further comprises an upper portion having threads on an interior surface thereof, which can be matingly engaged with the threads on the uppermost end of the drill stop member to secure the upper portion to the drill stop member.

11. The assembly of claim 10, wherein the upper portion has an opening defined therethrough corresponding with the opening in the drill stop member for receiving an insertion of the bit body therethrough.

12. The assembly of claim 11, wherein the upper portion has a threaded portion on an uppermost exterior surface.

13. The assembly of claim 12, wherein the assembly further comprises a cap portion having threads on an interior surface thereof.

14. The assembly of claim 13, wherein the cap portion has an opening corresponding with the opening in the drill stop member for receiving an insertion of the bit body therethrough.

15. The assembly of claim 12, wherein the threads of the cap portion can be matingly engaged with the threaded portion of the upper portion.

16. A seismic tool assembly for effecting a drill hole and enlarging a lowermost end thereof for a later insertion and setting of anchors therein, the assembly comprising:
a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body, and wherein the bit body further comprises an abutment member formed thereon having a greater width than a remainder of the bit body;
a drill stop member having an opening defined therethrough corresponding with the drill hole and for receiving an insertion of the bit body therethrough and comprising:
I. threads on an uppermost exterior surface thereof;
II. an upper portion having threads on an interior surface thereof, which can be matingly engaged with the threads on the uppermost exterior surface of the drill stop member to secure the upper portion to the drill stop member, the upper portion having opening defined therethrough corresponding with the opening in the drill stop member for receiving an insertion of the bit body therethrough;
a restrictive disk for substantially covering an upper surface of the drill stop member and having an opening defined therethrough corresponding with the drill hole and for receiving an insertion of the bit body therethrough, the opening of the restrictive disk having a shape which corresponds substantially to a shape of the cutting portion and the bit body;
a stabilizer for mounting within at least a portion of the drill hole and having a recessed interior portion which is constructed and arranged for having the drill stop member mounted thereon, the stabilizer further comprising:
(a) a flange portion constructed and arranged to extend into the drill hole and abut an inside portion thereof;
(b) a central opening corresponding with the opening of the drill stop member, the central opening providing a space between the bit body and the flange portion to permit limited tilting movement of the bit body during a drilling process to enlarge the lowermost end of the drill hole;
(c) a threaded portion on an upper interior surface of the stabilizer;
(d) a securing portion having an opening defined therethrough for receiving an insertion of the bit body therethrough, and corresponding with the central opening of the stabilizer, a lower end of the securing portion being threaded so as to permit threaded engagement of the securing portion to the threaded portion of the stabilizer so as to prevent disengagement of the drill stop member from the stabilizer during the drilling process; and
a cap portion having threads on an interior surface thereof, wherein the threads of the cap portion can be matingly engaged with the threaded portion of the upper portion of the drill stop member, the cap portion having an opening corresponding with the opening in the drill stop member for receiving an insertion of the bit body therethrough, and wherein the abutment member is constructed and arranged to contact an uppermost end of the drill stop member when the bit body is inserted therethrough, thus restricting downward movement of the bit body to a pre-set depth.

17. A seismic tool assembly for effecting a drill hole and enlarging a lowermost end thereof for a later insertion and setting of anchors therein, the assembly comprising:
a substantially cylindrical bit body sized to fit into the drill hole, the bit body having a first end region constructed and arranged to be operatively connected to a drill and a second end region disposed generally opposite said first end region, wherein a cutting portion is positioned to protrude from at least one side of the second end region, the cutting portion having an operational cutting radius greater than a cutting radius of the bit body, and wherein the bit body further comprises an abutment member formed thereon having a greater width than a remainder of the bit body;
a drill stop member having an opening defined therethrough corresponding with the drill hole and for receiving an insertion of the bit body therethrough, the drill stop member having threads on an uppermost exterior surface thereof;
a stabilizer for mounting within at least a portion of the drill hole and having a recessed interior portion which is constructed and arranged for having the drill stop member mounted thereon, the stabilizer further comprising:
(a) a flange portion constructed and arranged to extend into the drill hole and abut an inside portion thereof;
(b) a central opening corresponding with the opening of the drill stop member, the central opening providing a space between the bit body and the flange portion to permit limited tilting movement of the bit body during a drilling process to enlarge the lowermost end of the drill hole;
(c) a threaded portion on an upper interior surface of the stabilizer;
(d) a securing portion having an opening defined therethrough for receiving an insertion of the bit body therethrough, and corresponding with the central opening of the stabilizer, a lower end of the securing portion being threaded so as to permit threaded engagement of the securing portion to the threaded portion of the stabilizer so as to prevent disengagement of the drill stop member from the stabilizer during the drilling process; and
a cap portion having threads on an interior surface thereof, wherein the threads of the cap portion can be matingly engaged with the threaded portion of the upper portion of the drill stop member, the cap portion having an opening corresponding with the opening in the drill stop member for receiving an insertion of the bit body therethrough, and wherein the abutment member is constructed and arranged to contact an uppermost end of the drill stop member when the bit body is inserted therethrough, thus restricting downward movement of the bit body to a pre-set depth, and wherein the drill stop member permits a tilted controlled rotation within the stabilizer.

18. The assembly of claim 17, wherein the opening on the stabilizer has a diameter greater than a diameter of the cutting portion of the bit body, the opening providing a space between the bit body and the stabilizer to permit a greater range of tilting movement of the bit body to enlarge the lowermost end of the drill hole.

19. The assembly of claim 17, wherein the opening in the cap portion is positioned at a substantially central location of the cap portion.

20. The assembly of claim 1, wherein the flange portion is tapered at a distal end thereof.
